(19) United States
(12) Patent Application Publication
(10) Pub. No.: US 2017/0341725 A1
(43) Pub. Date: Nov. 30, 2017

(54) Motor-wing Gimbal Aircraft, Methods, and Applications

(71) Applicant: Edward Francis Skahan, Columbus, KS (US)

(72) Inventor: Edward Francis Skahan, Columbus, KS (US)

(21) Appl. No.: 15/168,081

(22) Filed: May 29, 2016

(51) Int. Cl. B64C 1/06; G05D 1/00; B64D 45/00; B64C 13/18; B64D 47/08; B64C 25/34; B64C 13/04; B64D 43/00; B64D 37/00; B64D 11/06; B64C 25/54; G08G 5/00; B64D 47/02

(52) U.S. Cl. CPC B64C 1/061; G08G 5/0034; G05D 1/0011; B64D 45/00; B64C 13/18; B64D 47/08; B64D 47/02; B64C 13/04; B64D 43/00; B64D 37/00; B64D 11/0696; B64C 25/54; B64C 25/34; B64D 2203/00; B64D 2221/00

(57) ABSTRACT

This invention, the Motor-wing Gimbal Aircraft (MGA) is an aerial vehicle and waterborne craft. It launches and lands vertically from the ground and water. In flight, it transitions from vertical, hovering and forward flight to horizontal flight. The MGA embodies multiple configurations and arrangements of motor-wings, propulsion systems and hybrid engine combinations. The MGA uses a fly-by-light system for flight maneuvering and controlling the motorized multi-axis gimbal cockpit. The MGA uses cellular communications together with the Global Positioning System (GPS) for navigation, collision avoidance and restricted airspace avoidance. The MGA uses visible lights to signal its elevation and flight maneuvers. The MGA is constructed of modular apparatuses and assemblies that are interchangeable and work in concert to power and maneuver the vehicle. This invention includes: the method of construction, the method of control, the method of visual light signaling, the method of electronic mapping of airspace (EMA) and the method of navigation. This invention includes flight operation applications and military applications.

### REFERENCES

U.S. Patent Documents:

| | | |
|---|---|---|
| 4,151,674 | May 1979 | Klahn, et al. |
| 5,115,996 | May 1992 | Moller |
| 5,797,054 | August 1998 | Paddock |
| 6,048,245 | April 2000 | Forti, et al. |
| 6,222,179 B1 | April 2001 | Mikan |
| 6,462,927 | October 2002 | Swinbanks |
| 6,708,943 B2 | March 2004 | Ursan |
| 6,886,776 | May 2005 | Wagner et al. |
| 8,083,494 B2 | December 2011 | Laforest et al. |
| 8,322,648 B2 | December 2012 | Kroetsch |
| 8,453,962 B2 | June 2013 | Shaw |
| 8,902,076 B2 | December 2014 | Pederson, et al. |
| 8,973,862 B2 | March 2015 | Marcus |
| 9,085,355 B2 | July 2015 | Delorean |
| 9,290,267 | March 2016 | Metreveli |
| 9,296,477 B1 | March 2016 | Coburn |
| 9,344,622 B2 | May 2016 | Kim |

Other Publications
Aeronautical Information Manual: December 2015; U.S. Department of Transportation/Federal Aviation Administration; Chapter 3. Airspace.

### SUMMARY

The present invention brings together a number of prior works to create a piloted aerial vehicle that is versatile, easy to operate and safe to fly. The Motor-wing gimbal aircraft (MGA) launches from and lands on most terrains and waterways. It can conduct flight operations from mobile platforms on the ground, water and in the air. It can dock with other MGAs in flight for refueling and fly in contact formation. While joined, the formation flies as one vehicle controlled by a single pilot. While in flight, the MGA uses lights to signal its flight maneuvers to other aerial vehicles. The MGA's pilot controls are fashioned after those used in computer gaming. This invention includes the method for electronically mapping airspace. This method divides unrestricted airspace into shelves reserved for vehicles flying in a particular heading. In addition, it surrounds objects, physical geography and natural occurring obstructions with two types of digital shields. The navigation system recognizes them. It will warn the pilot of approaching danger or restricted airspace and will act to avoid collisions or trespassing.

### BRIEF HISTORY

The MGA is inspired by, and a product of, the advancements in Unmanned Aerial Vehicles (UAVs). It represents a logical step forward in evolving UAVs into piloted aerial vehicles. UAVs have demonstrated their abilities for being stable platforms for payloads. Cameras have been mounted on them using gimbal assemblies. Here, the MGA uses a multi-axes gimbal assembly to accommodate the pilot. It keeps the pilot in a level position while conducting flight maneuvers. The pilot may elect to rotate their position within the gimbal assembly during flight. The multi-axes gimbal assembly allows the pilot to remain in a level position while transitioning from forward flight to horizontal flight. Horizontal flight allows the MGA to cruise at higher speeds.

### DESCRIPTION OF FIGURES

FIG. 1: Depicts the MGA in vertical, hovering or forward flight.

FIG. 2: Depicts the MGA in horizontal flight.

FIG. 3: Depicts the top view of the MGA in the ground start position.

FIG. 4: Depicts the front view of the MGA.

FIG. 5: Depicts the top view of the MGA's structural frame assembled.

FIG. 6: Depicts the bottom view of the MGA's structural frame disassembled.

FIG. 7: Depicts the top view of the cockpit apparatus.

FIG. 8: Depicts the bottom view of the cockpit apparatus.

FIG. 9: Depicts the top view of the cockpit apparatus with the upper canopy assembly in the open position.

FIG. 10: Depicts the bottom view of the seat platform assembly.

FIG. 11: Depicts the top view of the seat platform assembly.

FIG. 12: Depicts the motion of the gimbal assembly.

FIG. 13: Depicts a view of the gimbal assembly.

FIG. 14: Depicts a view of the motorized pivot assembly attached to the airframe structure.

FIG. 15: Depicts a section detail through the motorized pivot assembly.

FIG. 16: Depicts the gimbal and seat platform assemblies within the airframe structure assembly in the ground start position.

FIG. 17: Depicts the gimbal and seat platform assemblies within the airframe structure assembly in the horizontal flight start position.

FIG. 18: Depicts the bottom view of the airframe apparatus.

FIG. 19: Depicts the top view of the airframe apparatus.

FIG. 20: Depicts a view of the airframe apparatus with a section of airframe modular panels removed.

FIG. 21: Depicts a typical section detail through the airframe apparatus.

FIG. 22: Depicts the bottom view of motor-wing no.1 with c-wing extension deployed.

FIG. 23: Depicts the top view of motor-wing no.1 with c-wing extension retracted.

FIG. 24: Depicts a view of the c-wing assembly with a section of the c-wing modular panels removed.

FIG. 25: Depicts a typical section detail through the c-wing assembly.

FIG. 26: Depicts a section detail through the c-wing assembly at the gill module.

FIG. 27: Depicts a section detail through the c-wing at the female docking assembly.

FIG. 28: Depicts a section detail through the c-wing at the male docking assembly.

FIG. 29: Depicts a section detail through the c-wing at the extender assembly.

FIG. 30: Depicts a propeller quill rotating clockwise.

FIG. 31: Depicts a propeller quill rotating counter-clockwise.

FIG. 32: Depicts the upper safety grate assembly.

FIG. 33: Depicts the lower safety grate assembly.

FIG. 34: Depicts the right hand controller.

FIG. 35: Depicts the left hand controller.

FIG. 36: Depicts the touch-pad display assembly.

FIG. 37: Depicts the touch-pad display screen.

FIG. 38: Depicts the navigation display assembly.

FIG. 39: Depicts the navigation display screen.

FIG. 40: Depicts the view of the battery/fuel cells in the motor-wing and airframe apparatuses.

FIG. 41: Depicts the view of the fuel tanks/bladders in the motor-wing and airframe apparatuses.

FIG. 42: Depicts the view of the light-bracelet module.

FIG. 43: Depicts the top view of the light-bracelet assembly.

FIG. 44: Depicts two gimbal rings.

FIG. 45: Depicts one gimbal ring.

FIG. 46: Depicts the c-wing modules arranged and overlapped in a stacked configuration.

FIG. 47: Depicts the airframe modules arranged and overlapped in a stacked configuration.

FIG. 48: Depicts a two propeller assembly.

FIG. 49: Depicts a four propeller assembly.

FIG. 50: Depicts a five propeller assembly.

FIG. 51: Depicts a diagonal arrangement of propeller assemblies in a four motor-wing configuration.

FIG. 52: Depicts a parallel arrangement of propeller assemblies in a four motor-wing configuration.

FIG. 53: Depicts a diagonal arrangement of propeller assemblies in a six motor-wing configuration.

FIG. 54: Depicts a parallel arrangement of propeller assemblies in a six-motor-wing configuration.

FIG. 55: Depicts a pulse-jet quill assembly.

FIG. 56: Depicts a rocket quill assembly.

FIG. 57: Depicts a turbine quill assembly.

FIG. 58: Depicts a wheel landing gear assembly.

FIG. 59: Depicts a pad landing gear assembly.

FIG. 60: Depicts a ball landing gear assembly.

FIG. 61: Depicts a propeller propulsion petroleum powered quill assembly and a propeller propulsion electric powered quill assembly hybrid arrangement.

FIG. 62: Depicts a propeller propulsion petroleum powered quill assembly and a turbine quill assembly hybrid arrangement.

FIG. 63: Depicts a turbine quill assembly and pulse-jet quill assembly hybrid arrangement.

FIG. 64: Depicts a propeller propulsion electric powered quill assembly and a rocket quill assembly hybrid arrangement.

FIG. 65: Depicts one cockpit apparatus, one airframe apparatus and two motor-wing apparatuses and two non-powered quill assemblies.

FIG. 66: Depicts two cockpit apparatuses, two airframe apparatuses and four motor-wing apparatuses.

FIG. 67: Depicts one cockpit apparatus, two cargo container apparatuses, three airframe apparatuses and six motor-wing apparatuses.

FIG. 68: Depicts two cockpit apparatuses, two airframe apparatuses, four non-powered quill assemblies and one motor-wing apparatus with a counter-rotating propeller quill.

FIG. 69: Depicts control stations locations.

FIG. 70: Depicts the logic diagram of the fly-by light wireless control system.

FIG. 71: Depicts the pilot interface flight control diagram.

FIG. 72: Depicts launch, vertical flight and hovering flight.

FIG. 73: Depicts forward flight.

FIG. 74: Depicts horizontal flight.

FIG. 75: Depicts left turn.

FIG. 76: Depicts right turn.

FIG. 77: Depicts downwards flight.

FIG. 78: Depicts upwards flight.

FIG. 79: Depicts air braking.

FIG. 80: Depicts air-shelf signal mode.

FIG. 81: Depicts tilt signal mode.

FIG. 82: Depicts ascent/descent mode.

FIG. 83: Depicts turn signal mode.

FIG. 84: Depicts rotate signal mode.

FIG. 85: Depicts docking signal mode.

FIG. 86: Depicts launch and land signal modes.

FIG. 87: Depicts restricted airspace, unrestricted airspace, warning shields, ground zones and air shelves within the air column.

FIG. 88: Depicts warning and action shields surrounding a structure.

FIG. 89: Depicts warning and action shields surrounding a power line.

FIG. 90: Depicts warning and action shields surrounding a landing pad.

FIG. 91: Depicts warning and action shields surrounding a landing pad atop a structure.

FIG. 92: Depicts warning and action shields surrounding a road way.

FIG. 93: Depicts warning and action shields surrounding a bridge.

FIG. 94: Depicts warning and action shields surrounding a mountain range,

FIG. 95: Depicts warning and action shields surrounding a canyon.

FIG. 96: Depicts warning and action shields surrounding a waterway.

FIG. 97: Depicts warning and action shields surrounding a forest.

FIG. 98: Depicts warning and action shields surrounding a MGA.

FIG. 99: Depicts warning and action shields surrounding an aerial vehicle.

FIG. 100: Depicts warning and action shields surrounding a MGA carrier.

FIG. 101: Depicts warning and action shields surrounding a waterborne craft.

FIG. 102: Depicts warning and action shields surrounding an automobile.

FIG. 103: Depicts warning and action shields surrounding a train.

FIG. 104: Depicts warning and action shields surrounding a thunderstorm.

FIG. 105: Depicts warning and action shields surrounding a tornado.

FIG. 106: Depicts warning and action shields surrounding a fire.

FIG. 107: Depicts warning and action shields surrounding a volcano.

FIG. 108: Depicts the launch, flight and land sequences of manual and automatic navigation modes.

FIG. 109: Depicts the MGA land and launch from a flat ground surface.

FIG. 110: Depicts the MGA land and launch from a sloped ground surface.

FIG. 111: Depicts the MGA land and launch from an uneven ground surface.

FIG. 112: Depicts the MGA land and launch between structures.

FIG. 113: Depicts the MGA land and launch between trees.

FIG. 114: Depicts the MGA land and launch from a waterway.

FIG. 115: Depicts the MGA land, float and launch from a trepid waterway.

FIG. 116: Depicts the MGA overturning on a wave.

FIG. 117: Depicts the MGA overturned and afloat on a waterway.

FIG. 118: Depicts the MGA in contact formation with multiple MGAs.

FIG. 119: Depicts the MGA conducting flight operations off a mobile land platform.

FIG. 120: Depicts the MGA conducting flight operations off a mobile waterborne platform.

FIG. 121: Depicts the MGA conducting flight operations off a mobile airborne platform.

FIG. 122: Depicts a ground surface or waterway surface rescue mission.

FIG. 123: Depicts a ledge rescue mission.

FIG. 124: Depicts a waterway rescue mission.

FIG. 125: Depicts a hauling mission.

FIG. 126: Depicts an in-flight emergency.

### LIST OF DRAWINGS AND MASTER KEYNOTES LIST

Drawing 1: Illustrates views of the MGA in flight.
   Keynotes: 0100 not used, 0101 not used and 0102 MGA.
Drawing 2: Illustrates top and front views of the MGA.
   Keynotes: 0200 not used, 0201 not used, 0202 cockpit apparatus, 0203 airframe apparatus, 0204 motor-wing no.1 apparatus, 0205 motor-wing no.2 apparatus, 0206 motor-wing no.3 apparatus and 0207 motor-wing no.4 apparatus.
Drawing 3: Illustrates the top and bottom views of the MGA's structural fame.
   Keynotes: 0300 not used, 0301 not used, 0302 airframe structure assembly, 0303 motor-wing structure assembly, 0304 airframe c-channel, 0305 airframe arm, 0306 motor-wing ring, 0307 motor-wing arm, 0308 strut, 0309 motor-mount, 0310 quill body, 0311 motor-wing c-channel, and 0312 airframe ring.
Drawing 4: Illustrates top and bottom views of the cockpit apparatus.
   Keynotes: 0400 not used, 0401 not used, 0402 not used, 0403 not used, 0404 seat platform assembly, 0405 gimbal assembly, 0406 hull assembly, 0407 upper canopy assembly, 0408 vent, 0409 plug, and 0410 hinge.
Drawing 5: Illustrates top and bottom views of the seat platform assembly.
   Keynotes: 0500 not used, 0501 not used, 0502 bench seat assembly, 0503 console, 0504 platform, 0505 navigation display assembly, 0506 touch-pad display assembly, 0507 platform support ring, 0508 cargo hold hatch, 0509 power supply unit, 0510 environmental control system, 0511 right hand controller, 0512 left hand controller, 0513 accelerator foot pedal, 0514 brake pedal and 0515 master computer/navigation system.
Drawing 6: Illustrates the gimbal assembly.
   Keynotes: 0600 not used, 0601 not used, 0602 not used, 0603 not used, 0604 inner gimbal ring, 0605 middle gimbal ring, 0606 outer gimbal ring, 0607 motorized pivot assembly, 0608 housing, 0609 cover plate, 0610 communicating LED module, 0611 bearing plate, 0612 controller, 0613 motor, 0614 electrical contact ring, 0615 shaft, 0616 drive wheel and 0617 spacer plate.
Drawing 7: Illustrates the gimbal and seat platform assemblies within the airframe structure assembly.
   Keynotes: not used.
Drawing 8: Illustrates the top and bottom views of the airframe apparatus.
   Keynotes: 0800 not used, 0801 not used, 0802 airframe modular panel assembly, 0803 wench assembly, 0804 camera, 0805 railing assembly, and 0806 emergency parachute assembly.
Drawing 9: Illustrates a view and detail of the airframe apparatus.
   Keynotes: 0900 not used, 0901 not used, 0902 airframe top module, 0903 airframe middle module, 0904 airframe bottom module, 0905 airframe top sleeve module, 0906 airframe middle sleeve module, 0907 airframe bottom sleeve module, 0908 airframe access module, 0909 buoyant material, 0910 battery/fuel cell, 0911 fuel tank/bladder, 0912 wire harness, 0913 fuel line and 0914 fuel pump.
Drawing 10: Illustrates top and bottom views of motor-wing no.1.
   Keynotes: 1000 not used, 1001 not used, 1002 c-wing modular panel assembly, 1003 gill, 1004 male docking assembly, 1005 female docking assembly, 1006 extender assembly, 1007 c-wing extension, 1008 air turbulence ports, 1009 ailerons, 1010 light-bracelet assembly, and 1011 ladder.
Drawing 11: Illustrates a view and details of the c-wing assembly.
   Keynotes: 1100 not used, 1101 not used, 1102 not used, 1103 light-bracelet cover, 1104 c-wing access module, 1105 c-wing middle module, 1106 c-wing bottom module, 1107 c-wing bottom sleeve module, 1108 c-wing middle sleeve module, 1109 not used, 1110 not used, 1111 gill actuator and 1112 gill module.
Drawing 12: Illustrates details of the c-wing assembly.
   Keynotes: 1200 not used, 1201 not used, 1202 not used, 1203 docking housing, 1204 electromagnet, 1205 upper extender housing, 1206 lower extender housing, 1207 mounting bracket, and extender actuator 1208.
Drawing 13: Illustrates the quill assemblies.
   Keynotes: 1300 not used, 1301 not used, 1302 not used, 1303 not used, 1304 not used, 1305 quill body, 1306 clockwise propeller assembly, 1307 propeller nose cone, 1308 propeller landing gear assembly, 1309 counter-clockwise propeller assembly, 1310 clockwise propeller quill assembly, and 1311 counter-clockwise propeller quill assembly
Drawing 14: Illustrates the safety grate assemblies.
   Keynotes: 1400 not used, 1401 not used, 1402 upper safety grate assembly, 1403 wire grating, 1404 tubing structure, and 1405 lower safety grate.
Drawing 15: Illustrates the hand controllers.
   Keynotes: 1500 not used, 1501 not used, 1502 right hand rollerball, 1503 left hand controller housing, 1504 ground start position button, 1505 horizontal flight start position button, 1506 controller arm, 1507 left hand programmable button, 1508 right hand controller housing, 1509 flight transition button, 1510 autopilot button, 1511 right hand programmable button, 1512 touch-and-go button, 1513 docking button, 1514 level button, 1515 left hand roller ball, 1516 right click button, 1517 left click button, 1518 not used and 1519 hover button.
Drawing 16: Illustrates the touch-pad display assembly.
   Keynotes: 1600 not used, 1601 not used, 1602 touch-pad display housing, 1603 articulating arm, 1604 touch-pad display screen, 1605 pilot orientation and compass window, 1606 keypad window, 1607 variable window, 1608 side screen window, 1609 motor-wing gage window, 1610 cockpit gage window, 1611 computer operating system sub-window, 1612 environmental controls sub-window, 1613 cockpit lighting control sub-window, 1614 cockpit camera sub-window, 1615 camera system sub-window, 1616 programmable sub-window, 1617 motor-wing no.1 gages, 1618 motor-wing no.2 gages, 1619 motor-wing no.3 gages, 1620 motor-wing no.4 gages, 1621 cockpit power level gage, and 1622 airframe power level gage.
Drawing 17: Illustrates the navigation display assembly.
   Keynotes: 1700 not used, 1701 not used, 1702 navigation display housing, 1703 navigation display screen, 1704 power button, 1705 main navigation window, 1706 flight instruments window, 1707 tracking and orientation layer, 1708 airspace and ground zone map layer, 1709 satellite image map layer, 1710 weather layer, 1711 downward camera layer, 1712 road and street map layer, 1713 destination points and landing pads layer, 1714 flight path layer, 1715 programmable layer, 1716 view scale and compass layer, 1717 tracking trail, 1718 piloted MGA icon, 1719 landing pad icon, 1720 other MGA icon, 1721 other aerial vehicle icon, 1722 other aerial vehicle tracking trail, 1723 heading indicator, 1724 attitude indicator, 1725 turn coordinator, 1726 altimeter, 1727 air speed indicator, 1728 vertical speed indicator, 1729 GPS ground and air coordinates, 1730 ground speed indicator, and 1731 destination icon.
Drawing 18: Illustrates the power and distribution system.
   Keynotes: not used.
Drawing 19: Illustrates the fuel distribution system.
   Keynotes: not used.
Drawing 20: Illustrates the light-bracelet assembly.
   Keynotes: 2000 not used, 2001 not used, 2002 LED light module, 2003 white LED, 2004 red LED, 2005 blue LED, 2006 green LED and 2007 yellow.
Drawing 21: Illustrates the number and arrangement of the gimbal, airframe and c-wing assemblies.
   Keynotes: not used.
Drawing 22: Illustrates the number and arrangement of the propeller assembly.
   Keynotes: 2200 not used, 2201 not used, 2202 not used, 2203 not used, 2204 not used, 2205 not used, 2206 not used, 2207 two propeller assembly, 2208 four propeller assembly 2209 five propeller assembly, 2210 diagonal propeller assembly arrangement and 2211 parallel propeller assembly arrangement.
Drawing 23: Illustrates the types of quill and landing gear assemblies.
   Keynotes: 2300 not used, 2301 not used, 2302 not used, 2303 not used, 2304 not used, 2305 not used, 2306 wheel landing gear assembly, 2307 wheel assembly, 2308 ball landing gear assembly, 2309 ball assembly, 2310 turbine nose cone, 2311 turbine landing gear assembly, 2312 pulse-jet nose cone, 2313 pulse-jet landing gear assembly, 2314 rocket nose cone, 2315 rocket landing gear assembly, 2316 turbine quill assembly, 2317 pulse-jet quill assembly, 2318 rocket quill assembly, 2319 landing leg and 2320 landing pad.
Drawing 24: Illustrates hybrid motor-wing arrangements.
   Keynotes: 2400 not used, 2401 not used, 2402 not used, 2403 not used, 2404 propeller propulsion petroleum powered quill assembly and 2405 propeller propulsion electric powered quill assembly.
Drawing 25: Illustrates MGA configurations.
   Keynotes: 2500 not used, 2501 not used, and 2502 non-powered quill.
Drawing 26: Illustrates MGA configurations.
   Keynotes: 2600 not used, 2601 not used, 2602 counter-rotating propeller quill, 2603 motor-wing no.5, 2604 motor-wing no.6 and 2605 cargo container.
Drawing 27: Illustrates a view of control stations locations and the diagram of the fly-by-light wireless control system.
   Keynotes: 2700 not used, 2701 not used, 2702 not used, 2703 satellite, 2704 aerial vehicle, 2705 building, 2706 waterborne craft, 2707 automobile, 2708 person, 2709 MGA fleet carrier, 2710 pilot input controls, 2711 cockpit displays, 2712 computer system, 2713 controller, 2714 apparatus, assembly or component, 2715 sensor, and 2716 control station input controls and displays.
Drawing 28: Illustrates the pilot interface flight controls.
   Keynotes: not used.
Drawing 29: Illustrates launch, vertical flight, hovering flight, forward flight and horizontal flight.
   Keynotes: not used.
Drawing 30: Illustrates maneuvers in horizontal flight.
   Keynotes: not used.
Drawing 31: Illustrates light-bracelet signal modes.
   Keynotes: 3100 not used, 3102 not used, 3103 light-ball and 3104 air-shelf light-ball set.
Drawing 32: Illustrates light-bracelet signal modes.
   Keynotes: 3200 not used, 3201 not used, 3202 not used, 3203 not used, 3204 horizon light-ball set, 3205 roll light-ball set, 3206 rotate light-ball set, 3207 male light-ball set, 3208 female light-ball set and 3209 launch/land light-ball set.
Drawing 33: Illustrates an example of the air column and ground surface.
   Keynotes: 3300 not used, 3301 restricted air space, 3302 air column, 3303 air-shelf N, 3304 air-shelf E, 3305 air-shelf W, 3306 air-shelf S, 3307 air-shelf X, 3308 airspace warning shield, 3309 ground surface, 3310 ground zone 1, 3311 ground zone 2, and 3312 ground zone 3.
Drawing 34: Illustrates examples of the warning and action shields surrounding static manmade objects.
   Keynotes: 3400 not used, 3401 not used, 3402 not used, 3403 not used, 3404 not used, 3405 not used, 3406 warning shield, 3407 action shield, 3408 structure, 3409 power line, 3410 landing pad, 3411 road way, and 3412 bridge.
Drawing 35: Illustrates examples of the warning and action shields surrounding static natural objects
   Keynotes: 3500 not used, 3501 not used, 3502 not used, 3503 not used, 3504 mountain range, 3505 canyon, 3506 waterway and 3507 forest.
Drawing 36: Illustrates examples of warning and action shields surrounding dynamic manmade objects.
   Keynotes: 3600 not used, 3601 not used, 3602 not used, 3603 not used, 3604 not used, 3605 not used, and 3606 train.
Drawing 37: Illustrates examples of the warning and action shields surrounding dynamic natural objects.
   Keynotes: 3700 not used, 3701 not used, 3702 not used, 3703 not used, 3704 thunderstorm, 3705 tornado, 3706 fire, and 3707 volcano.
Drawing 38: Illustrates the method of navigation.
   Keynotes: 3800 not used, 3801 startup mode, 3802 flight plan revision mode, 3803 shield contact mode, 3804 docking mode, 3805 identified landing pad mode and 3806 unidentified landing zone mode.
Drawing 39: Illustrates the launch and land venues.
   Keynotes: 3900 not used, 3901 not used, 3902 not used, 3903 not used, 3904 not used, and 3905 tree.
Drawing 40: Illustrates Flight operations.
   Keynotes: 4000 not used, 4001 not used, 4002 not used, 4003 not used, 4004 not used, and 4005 wave.
Drawing 41: Illustrates MGA flight operations.
   Keynotes: 4100 not used, 4101 not used, 4102 not used, 4103 mobile land platform, 4104 mobile water platform and 4105 mobile air platform.
Drawing 42: Illustrates MGA flight operations missions.
   Keynotes: 4200 not used, 4201 not used, 4202 not used, 4203 not used, 4204 not used, 4205 cable, 4206 ledge, 4207 cargo container and 4208 emergency parachute.

General Statement

This statement applies to all information, embodiments, methods and applications described and illustrated herein. The following detailed descriptions and illustrations are set forth in order to provide a thorough understanding of the present invention. The present invention may be practiced without some or all of these specific details. In other instances, well known process operations, materials and assemblies which have not been described or illustrated in detail do not unnecessarily obscure the present invention. While the invention will be described in conjunction with the specific embodiments, it will be understood that it is not intended to limit the invention to the embodiments described herein. Practices and knowledge of the state of the art in the respected fields are employed to create this invention.

Unless specifically identified, the materials, mechanisms and methods of attachment used to make and assemble components, assemblies and apparatuses described and illustrated are those utilized within the standards of those respective industries. In most instances, the words, “component”, “assembly” or “apparatus” are omitted for clarity and conciseness.

Keynotes:

A four-digit keynote numbering system is used in this Document. It is used in the drawings, figures and text for reference, and to describe components, assemblies, apparatuses, sections, details, diagrams and views within an associated drawing, figure or description for clarity. If a keynote is used within the text without its definition, refer to the Master Keynotes List. If a conflict exists between the keynote text and the keynote number used within the text, the keynote number take precedence. Refer to the Master Keynote list for correct text. Bold numeric text is used for highlight. The keynote's first two numbers refer to a specific drawing. The second two numbers refer to the specific component, assembly, apparatus, section, detail, diagram or view within the drawing or figure, (e.g. keynote 1903=Drawing 19 component 03). The same number may appear on several drawings or figures and are used for reference to another component, assembly, apparatus, section, detail, diagram or view on another drawing or figure. In the event that a specific keynote text is “not used” the number remains in the Master Keynote List as a place holder. Not every apparatus, assembly or component is marked with a keynote. The keynote is typical for similar items.

### Definitions

Apparatus: The whole functioning machine consisting of assemblies and components working together to perform a particular act.

Assembly: A group of components working together forming a self-contained unit working for a purpose.

Component: A constituent part of an assembly to make it work.

Forward Flight: The act of moving forward through the air column utilizing the thrust generated by the motor-wings' propulsion systems where the MGA's motor-wings are parallel to the ground surface.

Horizontal Flight: The act of moving forward in the air column utilizing the thrust generated by the motor-wings' propulsion systems and the lift generated by the c-wings where the MGA's motor-wings are perpendicular to the ground surface.

Hovering Flight: The act of maintaining a geo-synchronistic position in the air.

Vertical Flight: The act of moving vertically through the air column utilizing the thrust generated by the motor-wings' propulsion systems where the MGA's motor-wings are parallel to the ground surface.

Abbreviations:

AGL: Above ground level

C-wing: Cylindrical-wing

EMA: Electronic Map of Airspace

Fig.: Figure

GPS: Global Positioning System

LED: Light Emitting Diode.

MGA: Motor-wing Gimbal Aircraft

V2L: Vertical Launch and Land

### DESCRIPTION

MGA:

The MGA is a heavier-than-air V2L vehicle that is airborne and waterborne. It uses downward thrust from its motor-wing apparatuses for vertical, hovering and forward flight. It uses forward thrust from its motor-wing apparatuses and lift from its c-wings to transition from forward flight to horizontal flight. In flight; the pilot, passenger and contents rotate within the cockpit apparatus along multiple axes to a preferred orientation. Each apparatus carries its own power system, fuel system, communication system, control system, and computer/navigation system. U.S. Pat. Nos. 8,973,862 B2; 9,296,477 B1; 5,115,996; 8,322,648 B2; 8,453,962 B2; 9,085,355 B2 and 6,886,776.

Drawing 1:

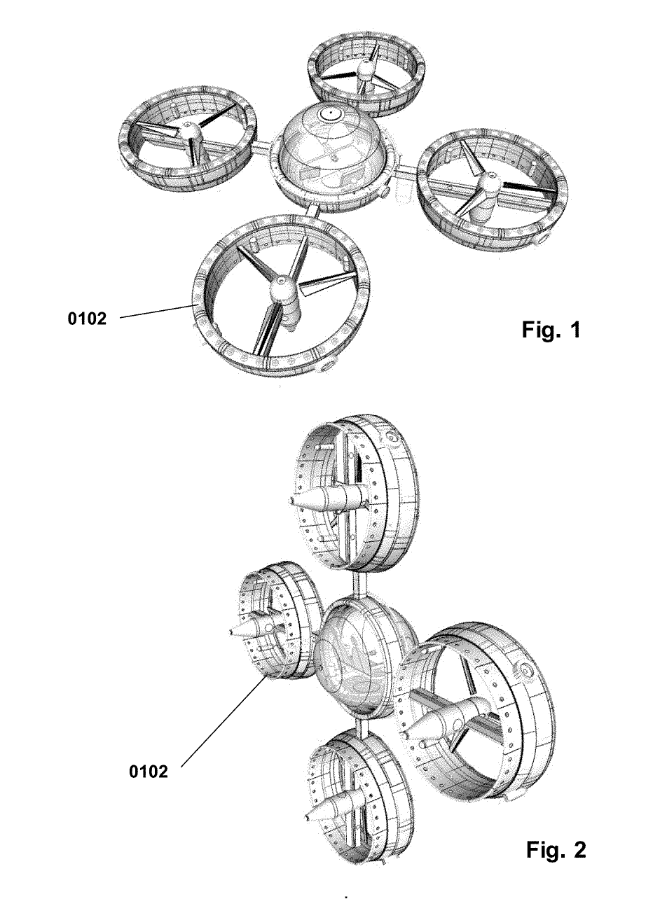

Illustrates views of the MGA in flight. FIG. 1 depicts the MGA 0102 in vertical, hovering and forward flight. FIG. 2 depicts the MGA 0102 in horizontal flight.

Drawing 2:

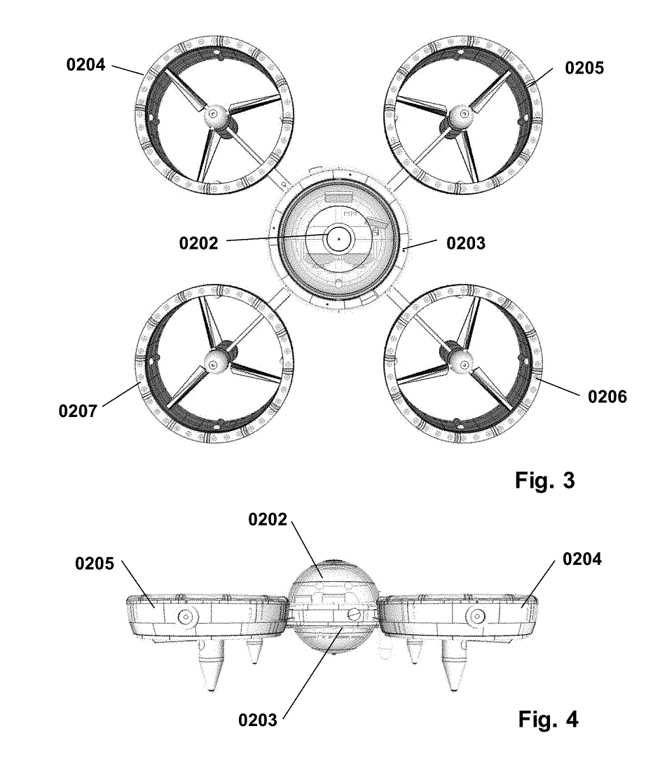

Illustrates top and front views of the MGA. FIG. 3 depicts the top view of the MGA in the ground start position. FIG. 4 depicts the front view of the MGA. MGA 0102 consist of: cockpit apparatus 0202, airframe apparatus 0203, motor-wing no.1 apparatus 0204, motor-wing no.2 apparatus 0205, motor-wing no.3 apparatus 0206, and motor-wing no.4 apparatus 0207. The ground start position is where MGA 0102 is on the ground and oriented accordingly: the pilot is level to the ground and faces forward; cockpit apparatus 0202 and airframe apparatus 0203 are level with the motor-wing apparatuses and motor-wing no.1 0204 is on the pilot's left forward side. The motor-wing apparatuses are numbered in the following clockwise order: motor-wing no.2 0205; motor-wing no.3 0206; and motor-wing no.4 0207.

Structural Frame:

The structural frame withstands the forces acting upon the MGA during flight operations. The forces include: aerodynamic forces, thrust and torque forces from the motors and impact forces. The motor-wing and airframe structure assemblies are modular and interchangeable. Components within each assembly are welded or molded together to form a unitized piece. U.S. Pat. No. 8,322,648 B2.

Drawing 3:

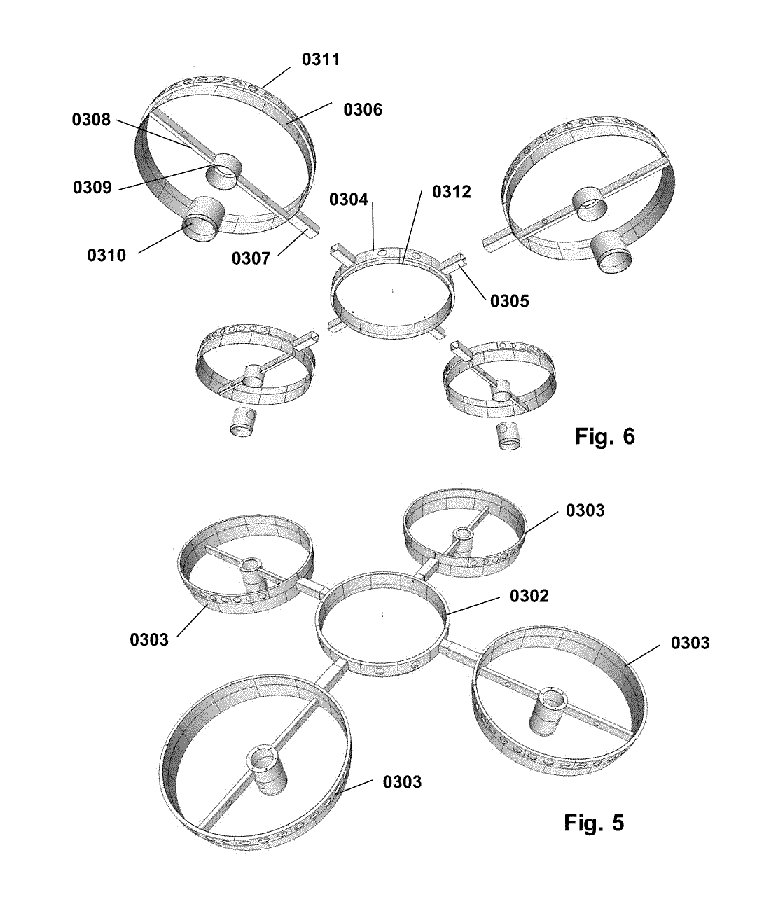

Illustrates the top and bottom views of the MGA's structural frame. FIG. 5 depicts the top view of the MGA's structural frame assembled. It consists of: airframe structure assembly 0302 and motor-wing structure assemblies 0303. FIG. 6 depicts the bottom view of the MGA's structural frame disassembled. Airframe structure assembly 0302 consists of: airframe c-channel 0304, airframe arm 0305 and airframe ring 0312. Motor-wing structure assembly 0303 consists of components: motor-wing ring 0306, motor-wing arm 0307, strut 0308, motor-mount 0309, quill body 0310 and motor-wing c-channel 0311. Access ports are arrayed around 0304 and 0311. Access ports are incorporated into 0308 and 0310.

Cockpit Apparatus:

The cockpit apparatus works under the principles of a multi-axis gimbal. The pilot, passenger and contents rotate along multiple axes within the cockpit apparatus. U.S. Pat. Nos. 5,797,054 and 6,708,943 B2.

Drawing 4:

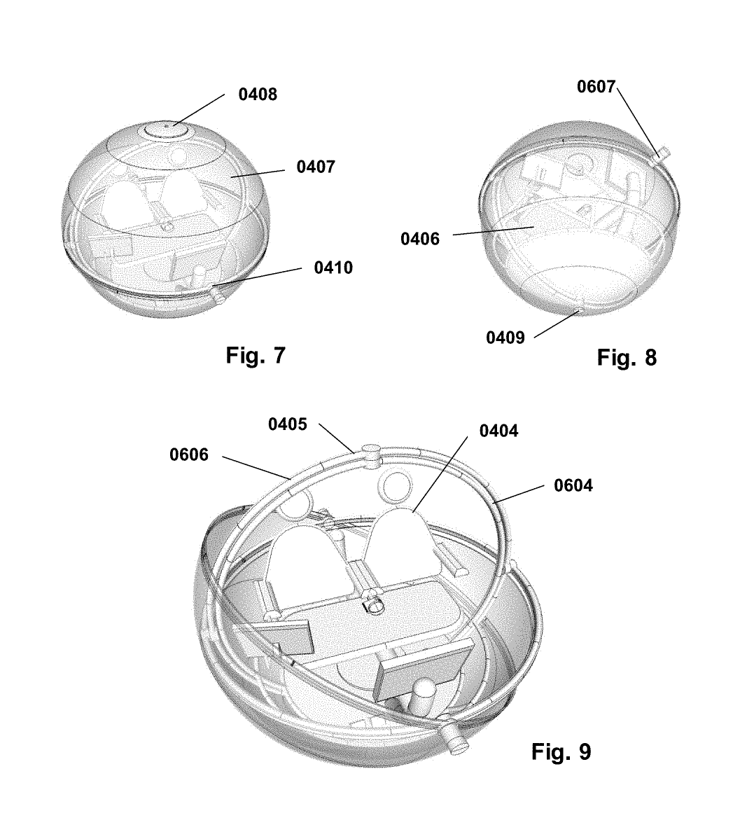

Illustrates top and bottom views of the cockpit apparatus. FIG. 7 depicts the top view of cockpit apparatus 0202. It highlights vent 0408 and upper canopy assembly 0407. FIG. 8 depicts the bottom view of cockpit apparatus 0202. It highlights plug 0409 and hull assembly 0406. FIG. 9 depicts the top view of cockpit apparatus 0202 with the upper canopy assembly 0407 in the open position. The cockpit apparatus 0202 consists of: seat platform assembly 0404, gimbal assembly 0405, hull assembly 0406, upper canopy assembly 0407, vent 0408, plug 0409 and hinge 0410. 0405 and 0406 are attached to outer gimbal ring 0606. Hinge 0410 is attached to motorized pivot assembly 0607 and allows the opening of upper canopy assembly 0407. 0406 and 0407 are made of a clear material to allow unrestricted views outside the cockpit apparatus.

Drawing 5:

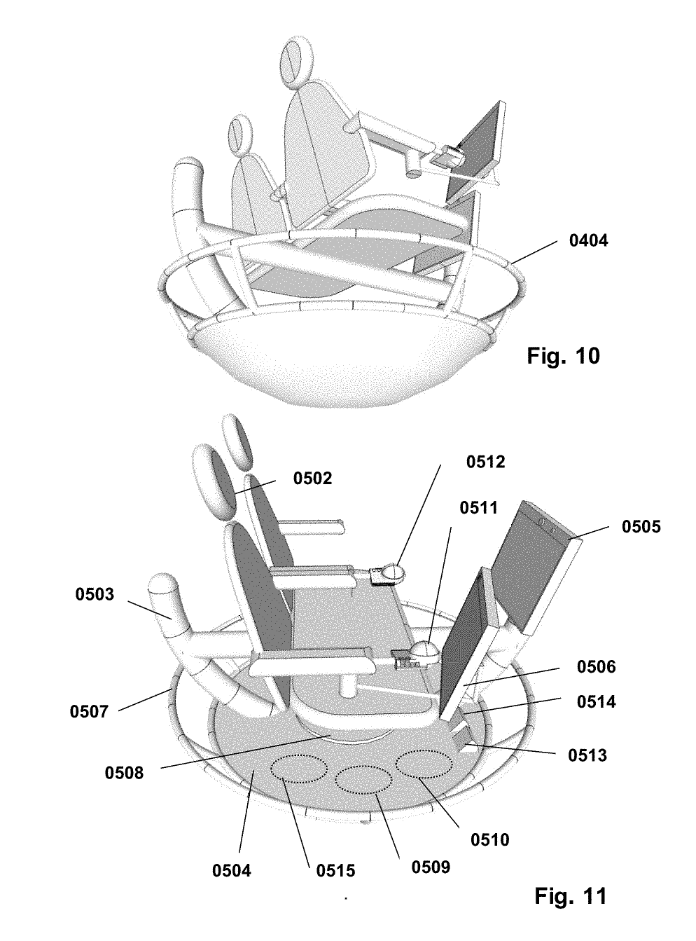

Illustrates top and bottom views of the seat platform assembly. FIG. 10 depicts the bottom view of seat platform assembly 0404. FIG. 11 depicts the top view of seat platform assembly 0404. 0404 consists of: bench seat assembly 0502, console 0503, platform 0504, navigation display assembly 0505, touch-pad display assembly 0506, platform support ring 0507, cargo hold hatch 0508, power supply unit 0509, environmental control system 0510, right hand controller 0511, left hand controller 0512, accelerator foot pedal 0513, brake pedal 0514 and master computer/navigation system 0515. 0404 is attached to inner gimbal ring 0604.

Drawing 6:

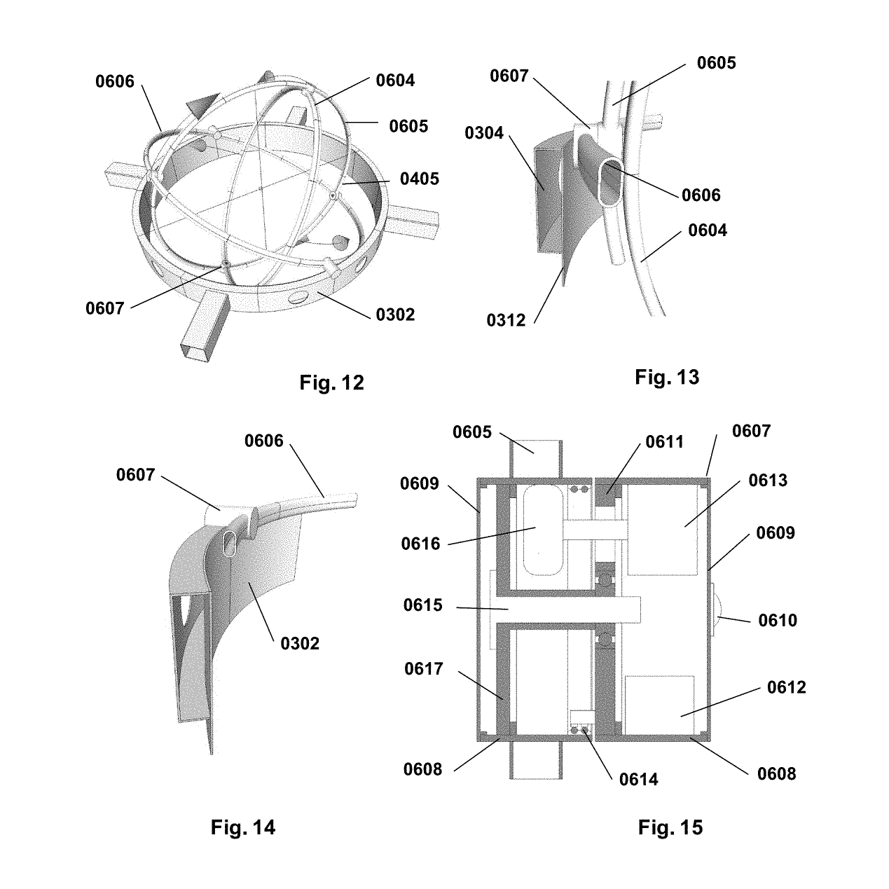

Illustrates the gimbal assembly. Gimbal rings are molded or welded to motorized pivot assemblies making unitized pieces. The gimbal rings are attached to one another by two motorized pivot assemblies placed opposite of each other. This restricts the rotational movement between any two gimbals along a single axis. The gimbal rings are sized to allow clear passage of each other while rotating along their respective axes and remain independent of the rotation of its support. FIG. 12 depicts the motion of gimbal assembly 0405 in pitch, yaw and roll within airframe structure assembly 0302. FIG. 13 depicts a view of the gimbal assembly 0405. Inner gimbal ring 0604 is attached to middle gimbal ring 0605 by motorized pivot assembly 0607. 0605 is attached to outer gimbal ring 0606 by 0607. FIG. 14 depicts a view of motorized pivot assembly 0607 attached to airframe structure 0302. FIG. 15 depicts a section detail of motorized pivot 0607. 0607 is a shaft and bearing combination that allows restricted movement along a single axis. 0607 consists of: housing 0608, cover plate 0609, communicating LED module 0610, bearing plate 0611, controller 0612, motor 0613, electrical contact ring 0614, shaft 0615, drive wheel 0616 and spacer plate 0617. Electrical current passes from one gimbal ring to another via electrical contact ring 0614.

Drawing 7:

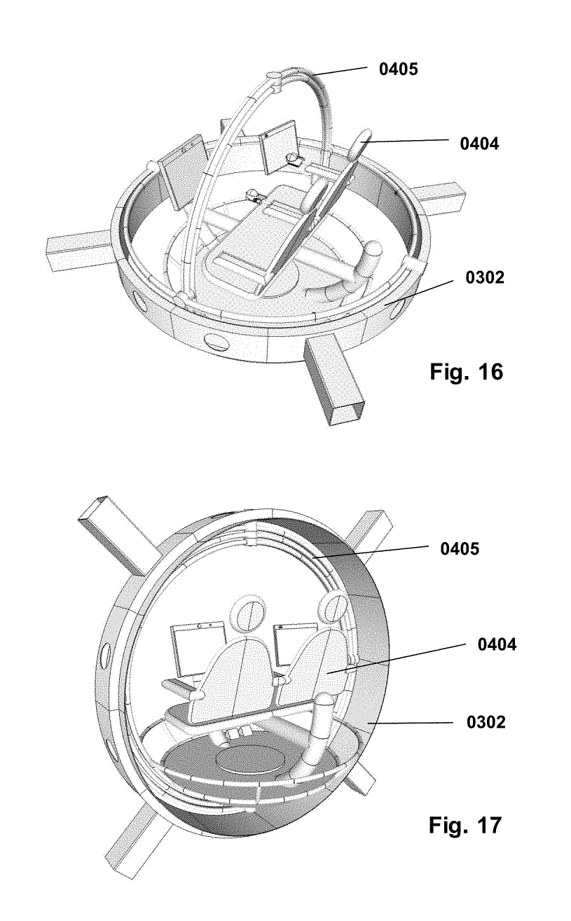

Illustrates the gimbal and seat platform assemblies within the airframe structure assembly. FIG. 16 depicts the gimbal and seat platform assemblies within the airframe structure assembly in the ground start position. FIG. 17 depicts the gimbal and seat platform assemblies within the airframe structure assembly in the horizontal flight start position. Here, the pilot is level to the ground.

### Other Embodiments

Canopy assemblies 0406 and 0407 are attached to inner gimbal ring 0604. 0406 and 0407 are attached to middle gimbal ring 0605. 0406 and 0407 are attached to airframe apparatus 0203. Environmental control system 0510 pressurizes cockpit apparatus 0202.

Airframe Apparatus:

The airframe apparatus supports the cockpit and motor-wing apparatuses. It carries a wench assembly for flight missions and deploys an emergency parachute for in-flight emergencies. U.S. Pat. No. 9,290,267.

Drawing 8:

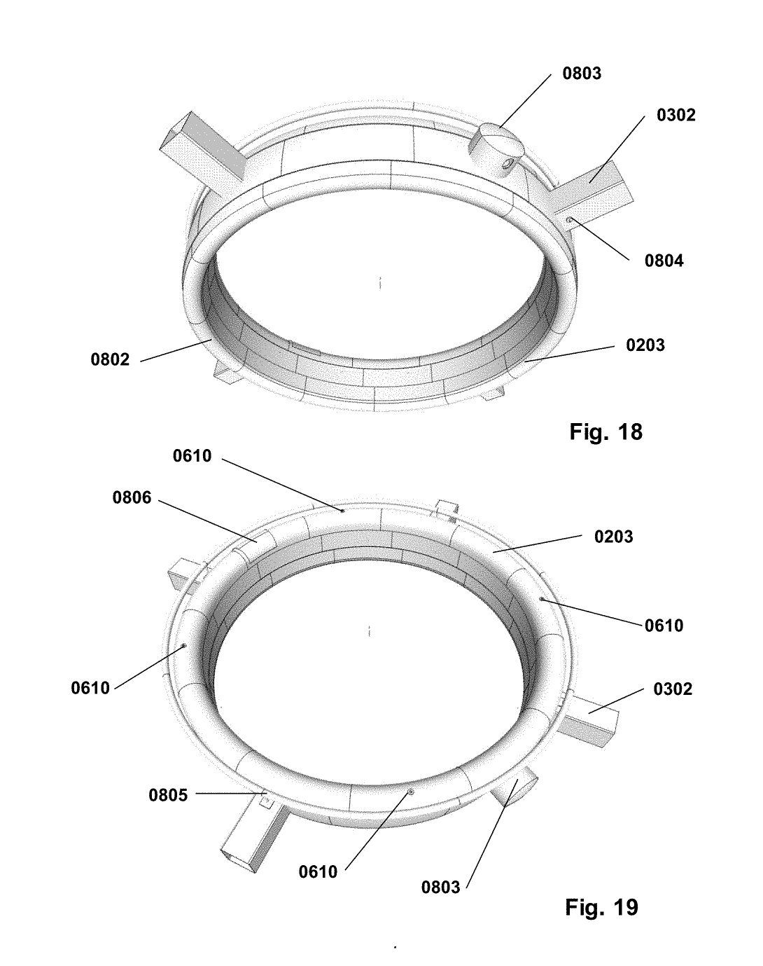

Illustrates the top and bottom views of the airframe apparatus. FIG. 18 depicts the bottom view of the airframe apparatus. FIG. 19 depicts the top view of the airframe apparatus. Airframe apparatus 0203 consists of: airframe structure assembly 0302, airframe modular panel assembly 0802, wench assembly 0803, camera 0804, railing assembly 0805, emergency parachute assembly 0806 and communicating LED module 0610.

Drawing 9:

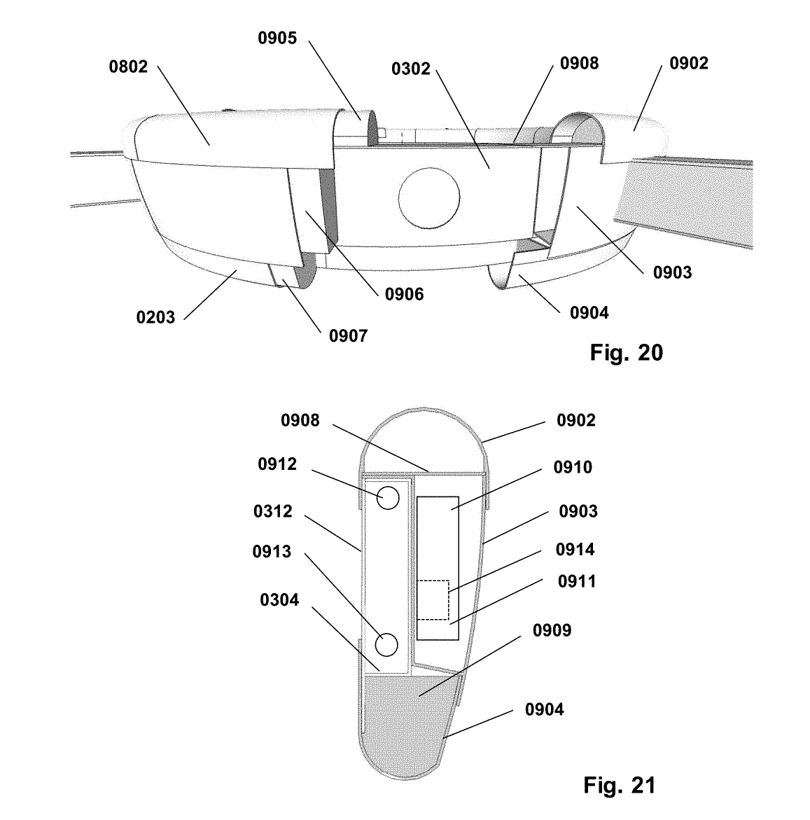

Illustrates a view and detail of the airframe apparatus. FIG. 20 depicts a view of the airframe apparatus with a section of airframe modular panels removed. It reveals the construction of the airframe apparatus. Airframe modular panel assembly 0802 consists of: airframe top module 0902, airframe middle module 0903, airframe bottom module 0904, airframe top sleeve module 0905, airframe middle sleeve module 0906, airframe bottom sleeve module 0907, and airframe access module 0908. FIG. 21 depicts a typical section detail through the airframe apparatus. It highlights buoyant material 0909, battery/fuel cell 0910, fuel tank/bladder 0911, wire harness 0912, fuel line 0913, and fuel pump 0914. 0909 fills part of the cavity of 0904.

### Other Embodiments

Additional wench assemblies 0803 attached to the airframe structure. Additional rail assemblies 0805 attached to the airframe structure for mounting other assemblies (e.g. a trolling motor).

Motor-Wing Apparatus:

The motor-wings work under the principles of rotary wing aircraft and cylindrical wings. The aircraft is kept stable by gyroscopic and counter-rotating effects of elements rotating around the shafts of its respective motor-wing apparatuses. The motor-wing apparatuses provide thrust in vertical, hovering and forward flight. They provide thrust and lift in horizontal flight. The c-wing varies its shape providing different aerodynamic characteristics during horizontal flight. The quills are interchangeable, accommodating various propulsion and engine types. The motor-wings accommodate a number of landing gear assemblies and safety equipment for soils conditions and mission types respectively. The motor-wing incorporates a light bracelet assembly that automatically signals elevation and flight maneuvers to other aircraft. The motor-wing incorporates docking ports for contact flight formation maneuvers. U.S. Pat. Nos. 4,151,674; 6,048,245 and 6,462,927.

Drawing 10:

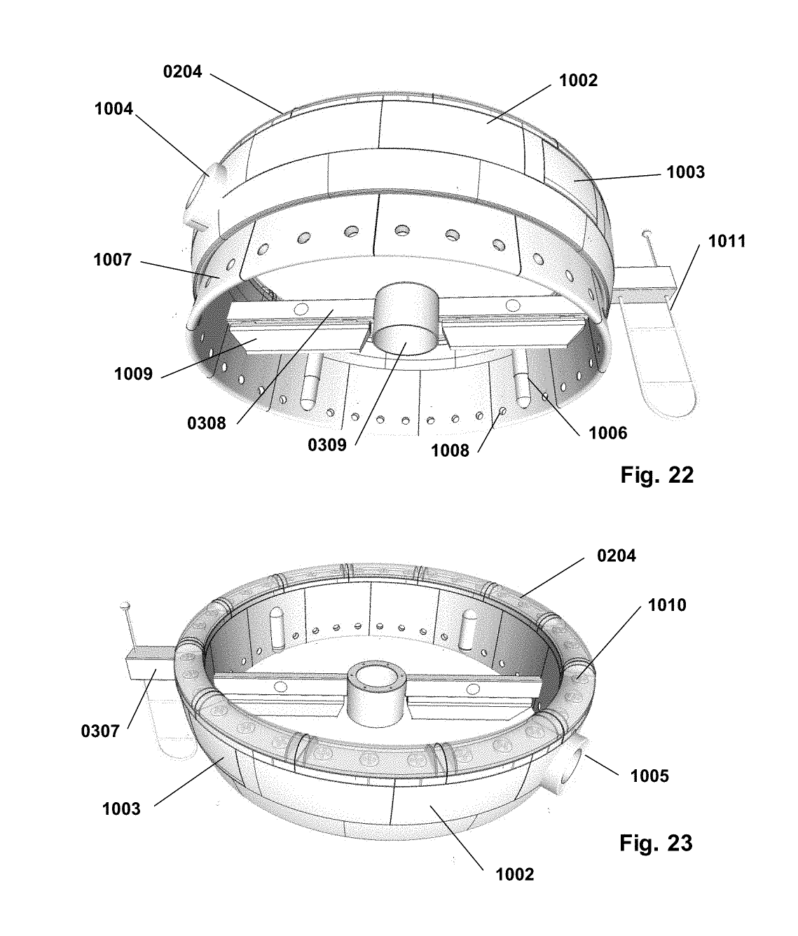

Illustrates top and bottom views of motor-wing no.1. The other motor-wings are similar. FIG. 22 depicts the bottom view of motor-wing no.1 with c-wing extension 1007 deployed. FIG. 23 depicts the top view of motor-wing no.1 with c-wing extension 1007 retracted. Motor-wing apparatus no.1 0204 consists of: motor-wing structure assembly 0303, c-wing modular panel assembly 1002, gill 1003, male docking assembly 1004, female docking assembly 1005, extender assembly 1006, c-wing extension 1007, air turbulence ports 1008, ailerons 1009, light-bracelet assembly 1010, and ladder 1011.

Drawing 11:

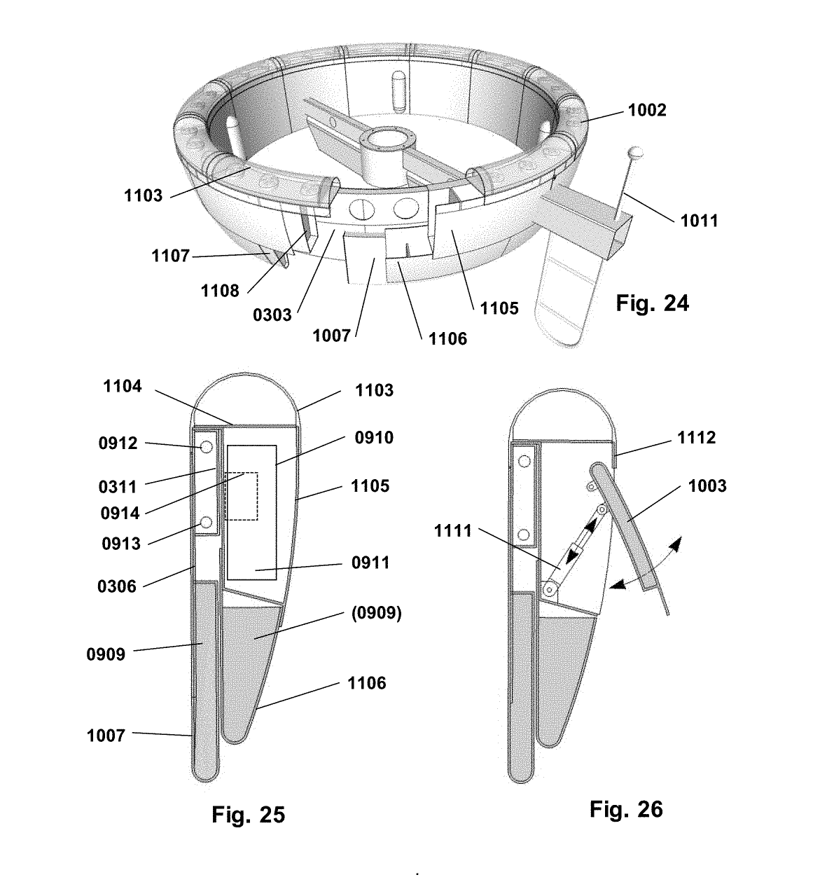

Illustrates a view and details of the c-wing assembly. The c-wing assembly acts as a wing and propeller shield. FIG. 24 depicts a view of the c-wing assembly with a section of the c-wing modular panels removed. FIG. 25 depicts a typical section detail through the c-wing assembly. C-wing assembly 1002 consists of: c-wing extension 1007, light-bracelet cover 1103, c-wing access module 1104, c-wing middle module 1105, c-wing bottom module 1106, c-wing bottom sleeve module 1107, c-wing middle sleeve module 1108, wire harness 0912, fuel line 0913, fuel pump 0914, motor-wing ring 0306, motor-wing c-channel 0311, buoyant material 0909, battery/fuel cell 0910 and fuel tank/bladder 0911. FIG. 26 depicts a section detail through the c-wing assembly at the gill module. Gill module 1112 consists of gill 1003 and gill actuator 1111. 1003 act as air brakes and trim tabs.

Drawing 12:

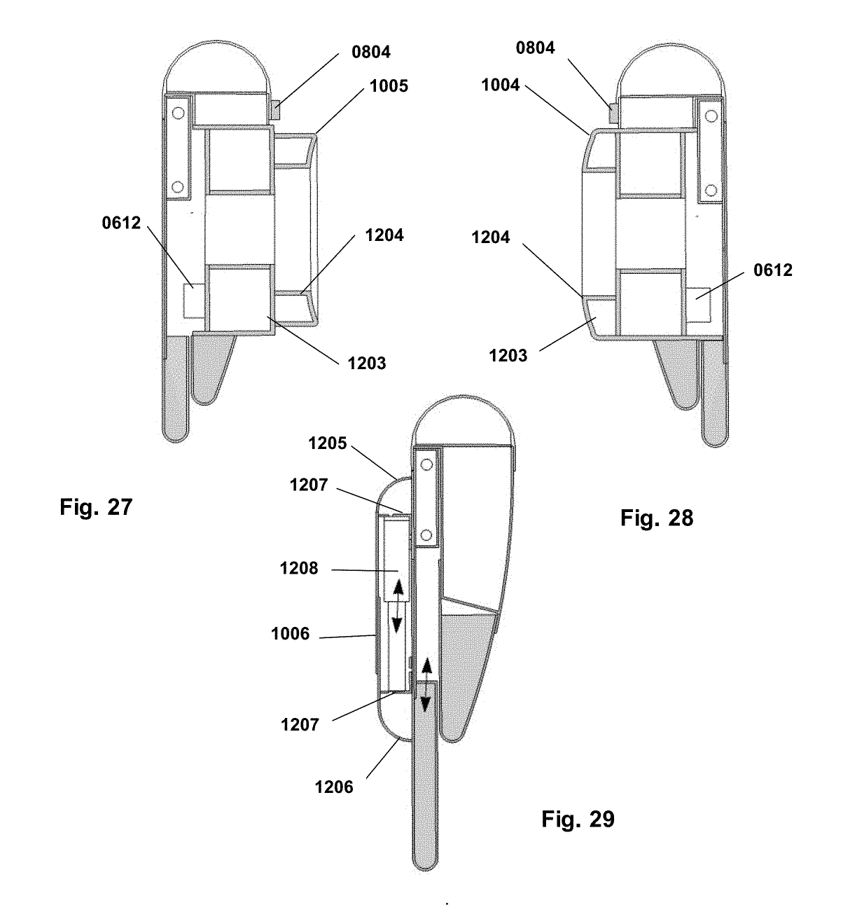

Illustrates details of the c-wing assembly. FIG. 27 depicts a section detail through the c-wing at the female docking assembly. FIG. 28 depicts a section detail through the c-wing at the male docking assembly. FIG. 29 depicts a section detail through the c-wing at the extender assembly. Female docking assembly 1005 consists of: docking housing 1203, electromagnet 1204, camera 0804 and controller 0612. Male docking assembly 1004 consists of: docking housing 1203, electromagnet 1204, camera 0804 and controller 0612. Extender assembly 1006 consists of: mounting brackets 1207, lower extender housing 1206, upper extender housing 1205 and extender actuator 1208. Camera 0804 aligns with other MGA's docking assembly during docking procedures.

Drawing 13:

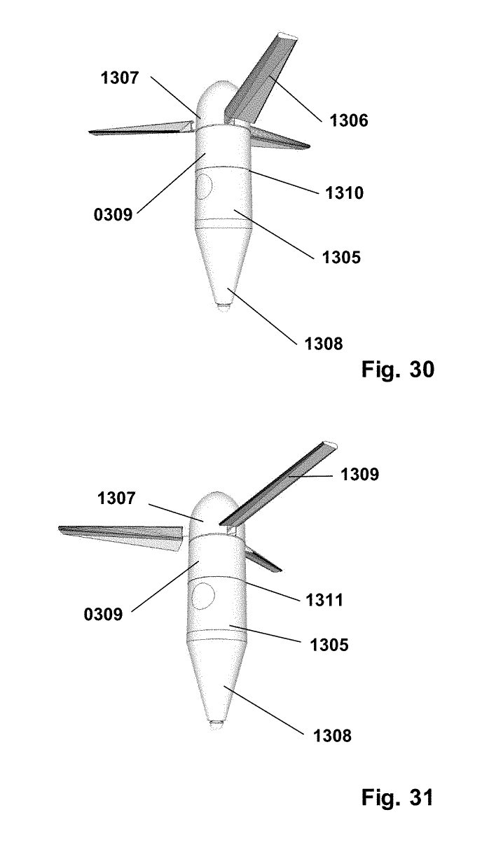

Illustrates the quill assemblies. Different engine types are mounted to motor-mount 0309. Engine and struts 0308 are not shown for clarity. The quills are interchangeable. FIG. 30 depicts a propeller quill rotating clockwise. Clockwise propeller quill assembly 1310 consists of: quill body 1305, clockwise propeller assembly 1306, propeller nose cone 1307, motor-mount 0309, and propeller landing gear assembly 1308. FIG. 31 depicts a propeller quill rotating counter-clockwise. Counter-clockwise propeller quill assembly 1311 consists of: quill body 1305, counter-clockwise propeller assembly 1309, propeller nose cone 1307, motor-mount 0309, and propeller landing gear assembly 1308. Quill body 1305 accommodates access panels.

Drawing 14:

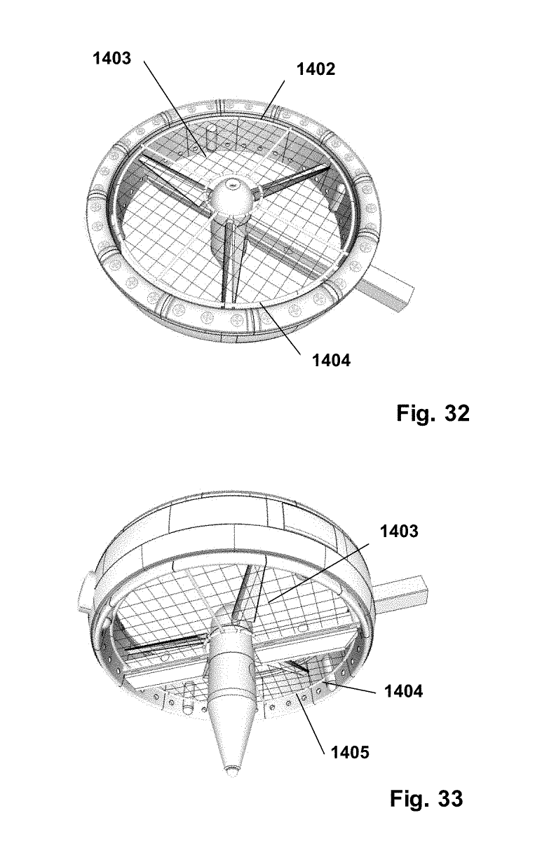

Illustrates safety grate assemblies. The safety grates act as propeller shrouds. FIG. 32 depicts the upper safety grate assembly. Upper safety grate assembly 1402 consists of: wire grating 1403 and tubing structure 1404. FIG. 33 depicts the lower safety grate assembly. Lower safety grate assembly 1405 consists of: wire grating 1403 and tubing structure 1404.

### Other Embodiments

Variable pitch propellers for propeller assembly 1310 and 1311. Propeller assemblies 1310 and 1311 auto-gyrate when not in use and are connected to generators or alternators to recharge power supplies in the MGA.

Pilot Input Controls and Displays System:

The pilot inputs commands through the hand controllers, display screens and foot pedals to operate the MGA and gimbal assembly. U.S. Pat. Nos. 6,222,179 B1 and 9,344,622 B2.

Drawing 15:

Illustrates the hand controllers. The left hand controller maneuvers the gimbal assembly. The right hand controller maneuvers the MGA.

Right Hand Controller:

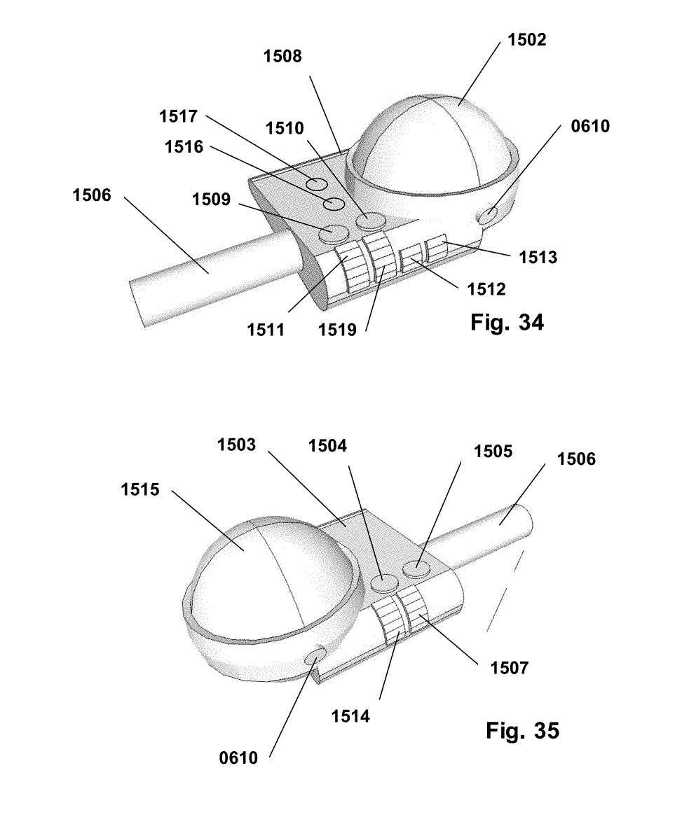

FIG. 34 depicts the right hand controller 0511. 0511 controls the direction of the MGA in pitch, yaw and roll. Right hand controller 0511 consists of: LED communicating module 0610, right hand rollerball 1502, controller arm 1506, right hand controller housing 1508, flight transition button 1509, autopilot button 1510, right hand programmable button 1511, touch-and-go button 1512, docking button 1513, right click button 1516, left click button 1517, and hover button 1519. The sensitivity of rollerball 1502 is adjustable.

Left Hand Controller:

FIG. 35 depicts the left hand controller 0512. 0512 controls the orientation of seat platform assembly 0404. Left hand controller 0512 consists of: left hand rollerball 1515, left hand controller housing 1503, ground start position button 1504, Horizontal flight start position button 1505, controller arm 1506, left hand programmable button 1507, level button 1514 and communicating LED module 0610. Rollerball 1515 engages gimbal assembly 0405 and moves platform assembly 0404 in direct response to the pilot's commands. The sensitivity of rollerball 1515 is adjustable.

Accelerator foot pedal 0513 increases and decreases the speed of the MGA. Power button 1704 turns the MGA on and off. Brake pedal 0514 engages the air brakes.

Drawing 16:

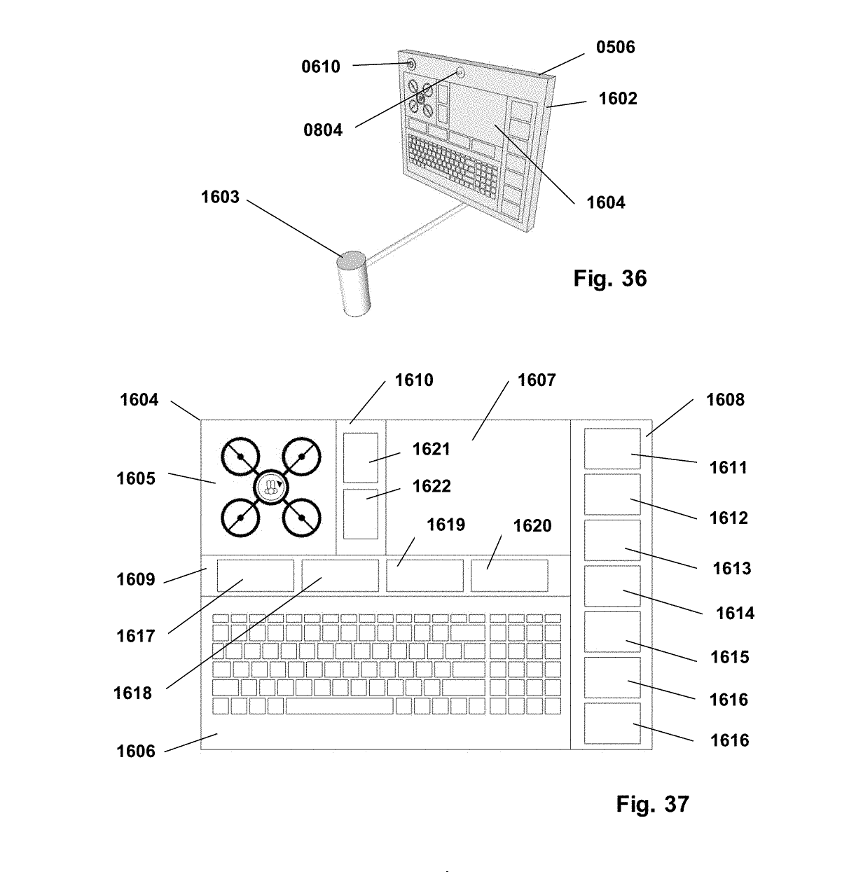

Illustrates the touch-pad display assembly. The touch-pad display screen consists of windows and sub-windows. Sub-windows slide over to fill the larger variable window. FIG. 36 depicts the touch-pad display assembly. Touchpad display assembly 0506 consists of: touch-pad display housing 1602, articulating arm 1603, touch-pad display screen 1604, communicating LED module 0610 and camera 0804.

Touch-Pad Display Screen:

FIG. 37 depicts the touch-pad display screen 1604. 1604 consists of: pilot orientation and compass window 1605, keypad window 1606, variable window 1607, side screen window 1608, motor-wing gage window 1609 and cockpit gage window 1610. Sub-windows consist of: computer operating system sub-window 1611, environmental controls sub-window 1612, cockpit lighting control sub-window 1613, cockpit camera sub-window 1614, camera system sub-window 1615 and programmable sub-windows 1616 (e.g. wench assembly controls window). Keypad window 1606 consists of a computer keyboard. Motor-wing gage window 1609 consists of: motor-wing no.1 gages 1617, motor-wing no.2 gages 1618, motor-wing no.3 gages 1619, and motor-wing no.4 gages 1620. Motor-wing gages include: power levels, fuel levels, tachometers and temperature levels. Cockpit gage window 1610 consists of: cockpit power level gage 1621 and airframe power level gage 1622. Arrow in pilot orientation and compass screen 1605 indicates north.

Drawing 17:

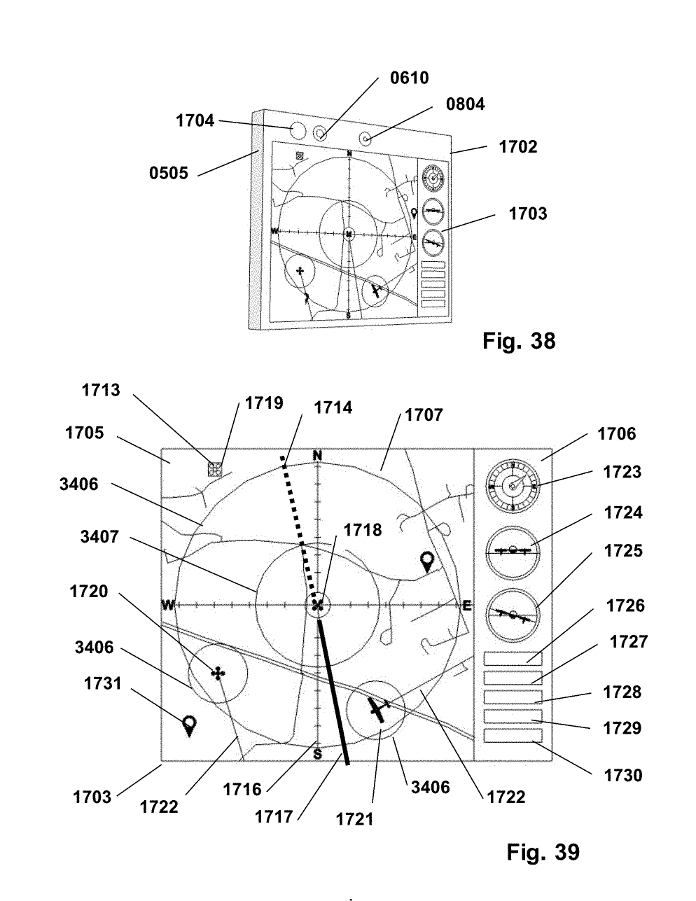

Illustrates the navigation display assembly. FIG. 38 depicts the navigation display assembly. FIG. 39 depicts the navigation display screen. The navigation display assembly assists the pilot in navigating through airspace. Navigation display assembly 0505 consists of: navigation display housing 1702, navigation display screen 1703, power button 1704, communicating LED module 0610 and camera 0804.

Navigation Display Screen:

FIG. 39 depicts the Navigation display screen 1703. 1703 consists of: main navigation window 1705 and flight instruments window 1706. The information displayed on main navigation window 1705 is shown as transparent overlays. They have different opacity levels for clarity. They are registered at the same scale and the scale can vary (e.g. from a one mile radius to a five mile radius). The layers can be turned on and off. Layers displayed on main navigation window 1705 include: tracking and orientation layer 1707, airspace and ground-zone map layer 1708, satellite image map layer 1709, weather layer 1710, downward camera layer 1711, road and street map layer 1712, destination points and landing pads layer 1713, flight path layer 1714 and programmable layer 1715. Layers 1708, 1709, 1710, 1711 and 1715 are not shown in FIG. 39 for clarity. The tracking and orientation layer 1707 depicts and tracks aerial vehicles and their corresponding dynamic warning shields 3406. They are represented as screen icons: tracking trail 1717, piloted MGA icon 1718, landing pad icon 1719, other MGA icon 1720, other aerial vehicle icon 1721 and other aerial vehicle tracking trail 1722. The tracking and orientation layer 1707 depicts a view scale and compass.

Flight Instruments Window:

Flight instruments window 1706 includes: heading indicator 1723, attitude indicator 1724, turn coordinator 1725, altimeter 1726, air speed indicator 1727, vertical speed indicator 1728, GPS ground and air coordinates 1729 and ground speed indicator 1730. 1725 displays barometric and AGL measurements.

### Other Embodiments

Rollerballs 1502 and 1515 can be joysticks or buttons.

Power and Distribution System:

The MGA receives and produces electrical power. It receives electrical power from battery/fuel cells arrayed and placed within the middle module located in the airframe and motor-wing apparatuses. The Battery is reenergized from electrical current received from recharging stations or from generators, or alternators, associated with motor-wing types having rotating shafts. Fuel cells can be recharged from gas (e.g. Hydrogen or natural gas). The power is conditioned according to the requirements of the assemblies and components being energized. Wire harnesses contain the wiring within each apparatus. The cavities within the airframe structure, motor-wing structure and gimbal assembly serve as raceways. The power distribution system is connected amongst the airframe and motor-wings. A disconnect is used when attaching the motor-wings to the airframe. The MGA recharges while airborne during docking procedures through the docking assemblies.

Drawing 18:

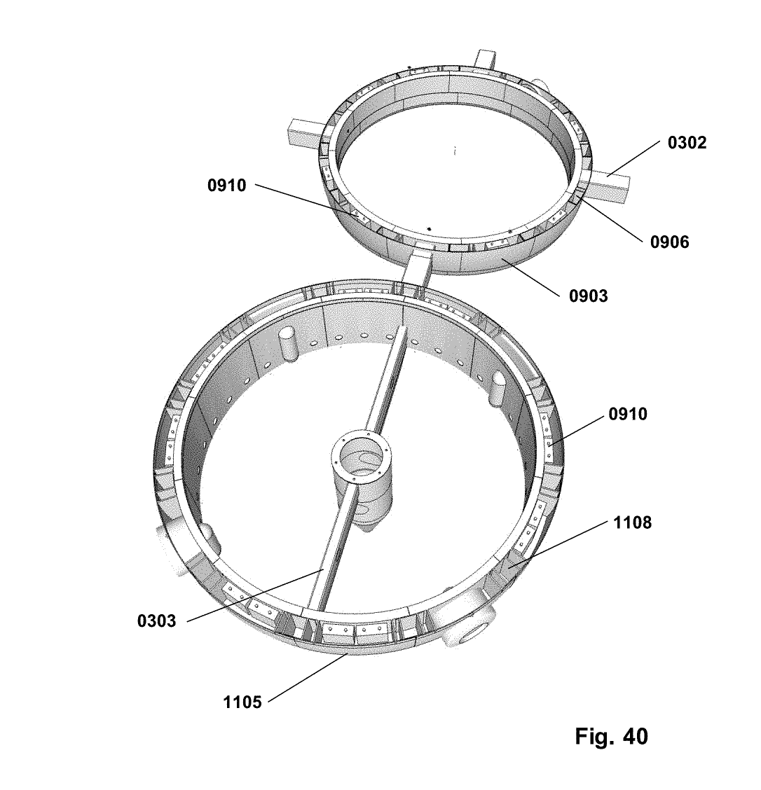

Illustrates the power and distribution system. FIG. 40 depicts the view of the battery/fuel cells in the motor-wing and airframe apparatuses. The power distribution system consists of: battery/fuel cell 0910 and wire harness 0912. FIG. 15 depicts a section detail through the motorized pivot assembly. It highlights electrical contact ring 0614 that transfers electrical current across the motorized pivot assembly.

Fuel and Distribution System:

The type of fuel used in the MGA is dependent on the type of engine used in the motor-wing apparatuses. There are two types of fuels used in the MGA: petroleum based and non-petroleum based products. Petroleum based fuels (e.g. aviation gasoline or jet fuel) comply with the engine manufacturer's specifications. Non-petroleum fuels include: electric energy produced from batteries or fuel cells, energy produce directly from gas (e.g. hydrogen) or energy produced from liquid or solid propellants. Fuel tanks/bladders are arrayed and placed within the airframe middle module and the c-wing middle module. The cavity within the airframe structure and the c-wing structure serve as raceways. Fuel lines connect the fuel tanks/bladders and deliver fuel to the engine via fuel pumps. The fuel distribution system is connected amongst the airframe and motor-wings. A fuel line disconnect is used when attaching the motor-wings to the airframe. The fuel pumps are located within the middle module of the c-wings and airframe, and quills. The MGA can refuel while airborne during docking procedures through the docking assemblies.

Drawing 19:

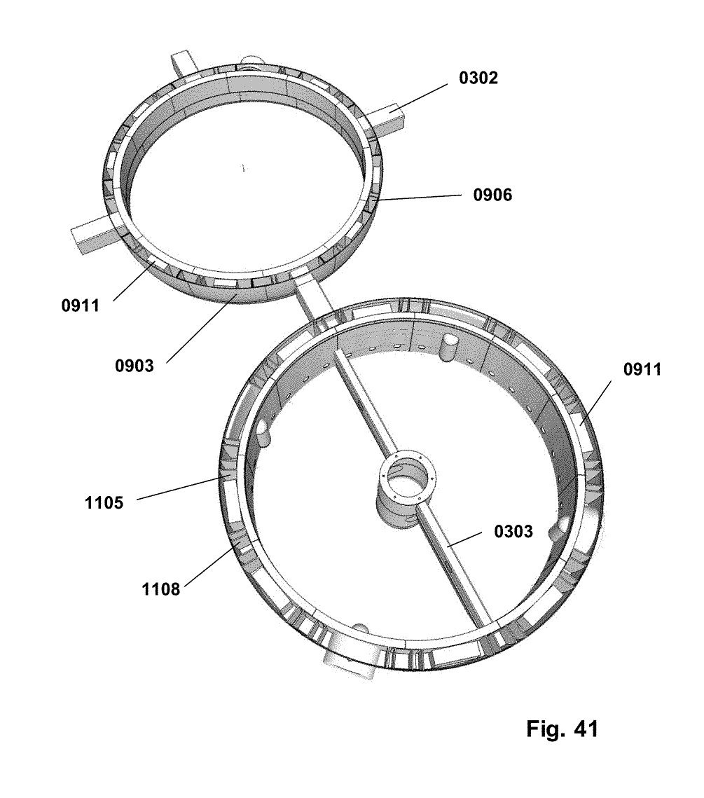

Illustrates the fuel distribution system. FIG. 41 depicts the view of the fuel tanks/bladders in the motor-wing and airframe apparatuses. The fuel distribution system consists of: fuel tank/bladder 0911, fuel line 0913 and fuel pump 0914.

Lighting Systems:

Lighting systems include general purpose lighting for the cockpit interior and signal lighting. General purpose interior lights are integrated in the motorized pivots along the pilot's side surface of the gimbal rings. They are controlled from the touch-pad display screen. They act as general illumination and map reading lights. They are dimmable. The light-bracelet assembly acts as the signal light system. It forms the leading edge of the c-wing. It operates automatically when the MGA is in operation. Light intensity is automatically adjusted according to weather and daylight conditions. The light-bracelet assembly illuminates in different colors and different flashing sequences. It acts as running lights and has a number of display mode functions.

Drawing 20:

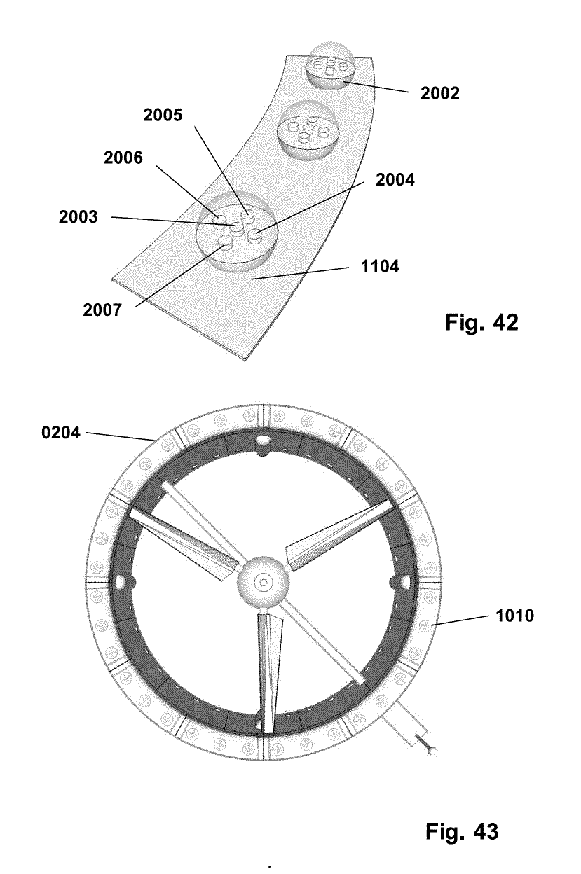

Illustrates the light-bracelet assembly. FIG. 42 depicts the view of the light-bracelet module. FIG. 43 depicts the top view of the light-bracelet assembly. Light-bracelet assembly 1010 consists of: light-bracelet cover 1103, c-wing access module 1104, LED light module 2002, white LED 2003, red LED 2004, blue LED 2005, green LED 2006 and yellow LED 2007. Hues in the visible light spectrum can be produced with these colored lights.

Camera System:

There are cameras mounted on the MGA that serve a number of functions. First, there are cameras used to assist in video communication. They are located within the cockpit apparatus. Second, there are forward, aft and downward cameras used to assist in navigation. They are located on the airframe. Third, there are cameras used to assist with docking procedures. They are located above the docking assemblies on the c-wing. Fourth, there are cameras used to assist with rescue operations. They are located on the airframe. The camera system is controlled by the pilot via the touch-pad screen located on the seat platform assembly.

Information System:

The computer/navigation system serves a number of functions. First, the computer system processes data using the computer's operating system. Second, it receives commands from the pilot or control station. It processes the input commands and sends calibrated commands to the apparatuses and their respective assemblies' controller. It receives data from the assemblies' sensors, process the data and may resend additional calibrated commands to achieve the desired output. It sends the measured output to the display screens Third, it assists in navigation. Fourth, it records data and video of the flight operations. The computer is located in the cargo hold underneath the seat platform. The computer interfaces with the pilot via the controls and displays located on the seat platform assembly.

Communication Systems:

There are two communication networks associated with the MGA: the external network and the onboard network. The external network carries communications to and from control stations located outside the MGA. The MGA carries a radio/transponder for external network connections. It is located in the cargo hold underneath the seat platform assembly. The onboard network carries communications to and from apparatuses and assemblies to the computer/navigation system. The information transmitted and received includes voice, video and data. Communication is sent and received via LED communicating modules. They are located throughout the MGA. Specifically, they are located on: right hand controller 0511, left hand controller 0512, navigation display 0505, touch-pad display 0506, accelerator foot pedal 0513, brake pedal 0514, airframe 0203, motor-wing no.1 0204, motor-wing no.2 0205, motor-wing no.3 0206, motor-wing no.4 0207 and quill bodies 1305. U.S. Pat. No. 8,902,076 B2.

Buoyancy:

The MGA is a waterborne craft. The amount of water (its weight) displaced by hull assembly 0406 and motor-wings 0204, 0205, 0206 and 0207 is greater than the weight of the MGA. The motor-wings act as outriggers to stabilized the craft on top of the water.

### Methods

Method of Manufacturing:

This method of manufacturing uses interchangeable modular apparatuses, assemblies and components. They are fitted together and arranged, like building blocks, in numerous ways to construct various MGA configurations. These configurations are tailored to accomplish their intended flight missions. The following methods include the number and arrangement of the MGA's assemblies, apparatuses and components.

Drawing 21:

Illustrates the number and arrangement of the gimbal, airframe and c-wing assemblies.

Seat Platform Assemblies:

The cockpit apparatus accommodates seating for one or multiple passengers. FIG. 9 depicts seating platform assembly 0404 for the pilot and passenger in a bench seating arrangement. The seating platform can be configured for additional passengers. It can be configured for a back to front seating arrangement.

Gimbal Assemblies:

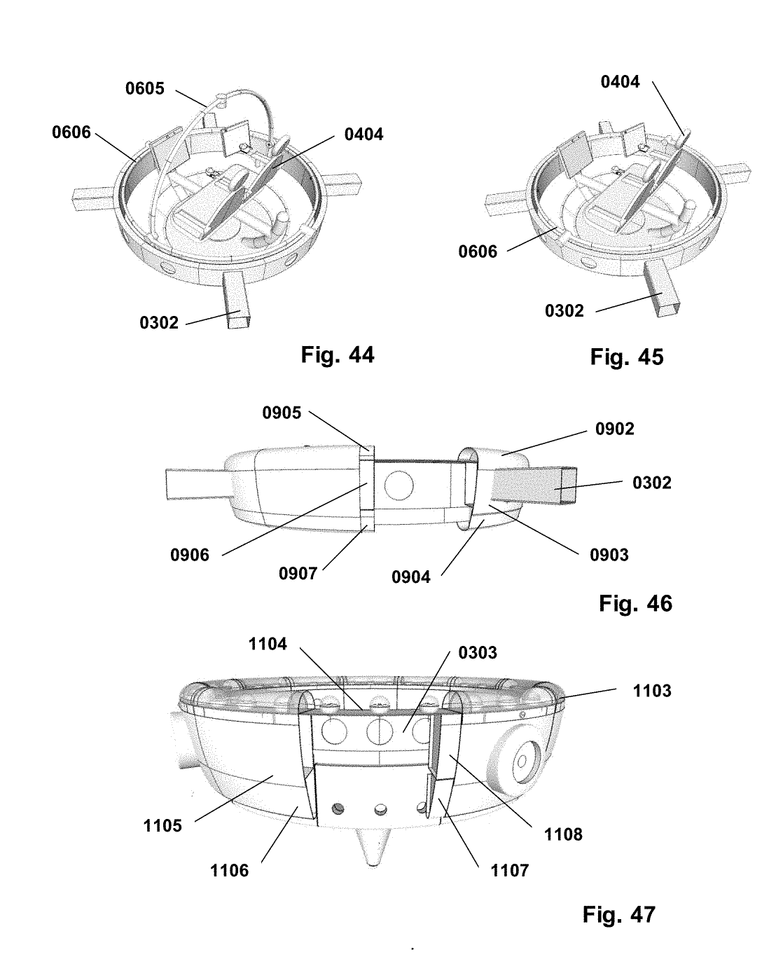

The cockpit apparatus 0202 accommodates one or multiple gimbal ring assemblies. FIG. 45 depicts one gimbal ring 0606. FIG. 44 depicts two gimbal rings, 0606 and 0605. FIG. 12 depicts three gimbal rings, 0604, 0605 and 0606. The gimbal assembly can be arranged so that each gimbal ring can rotate along a different axis than shown (e.g. the inner gimbal ring can rotate along the x, y or z axis).

Airframe Modular Panels:

The number and arrangement of airframe modular panels can vary. Airframe modules 0902, 0903 and 0904 and their respective sleeves 0905, 0906 and 0907 can be arranged and overlapped in a number of configurations. FIG. 20 depicts the airframe modules arranged and overlapped in a staggered configuration. FIG. 46 depicts the airframe modules arranged and overlapped in a stacked configuration. The number of segments around the airframe and c-wing can increase or decrease from what is shown.

C-Wing Modular Panels:

The number and arrangement of c-wing modules can vary. C-wing modules 1103, 1105 and 1106 and their respective access and sleeve modules 1104, 1107 and 1108 can be arranged and overlapped in a number of configurations. FIG. 24 depicts the c-wing modules arranged and overlapped in a staggered configuration. FIG. 47 depicts the airframe modules arranged and overlapped in a stacked configuration. The number of segments around the c-wing can increase or decrease from what is shown.

Propeller Assemblies:

The MGA accommodates various propeller assemblies and arrangements.

Drawing 22:

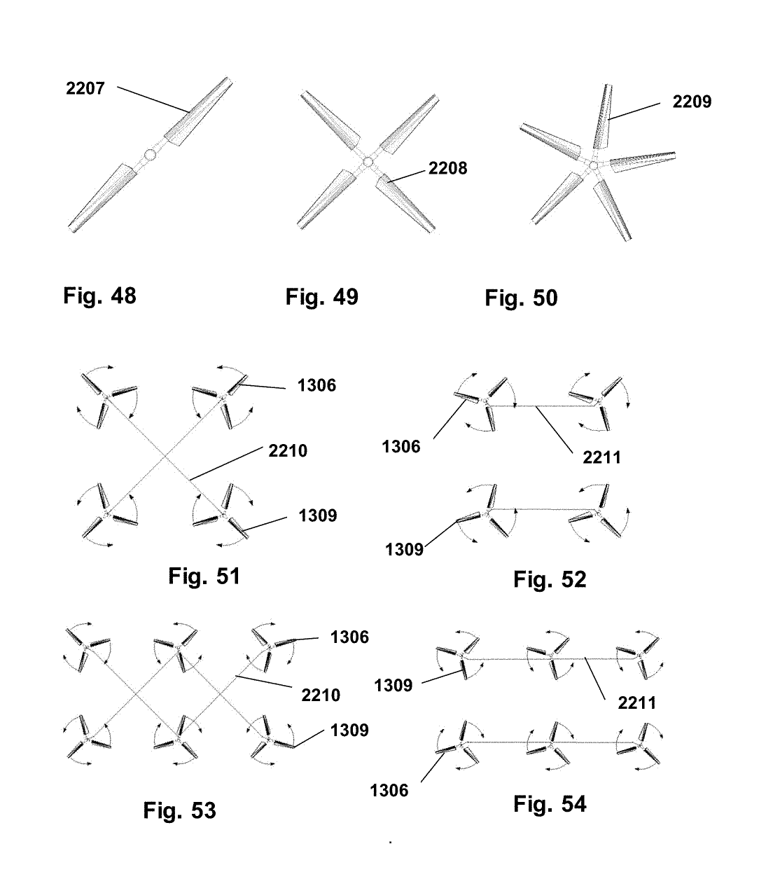

Illustrates the number and arrangement of the propeller assembly. FIG. 48 depicts a two propeller assembly. FIG. 49 depicts a four propeller assembly. FIG. 50 depicts a five propeller assembly. FIG. 51 depicts a diagonal arrangement of propeller assemblies in a four motor-wing configuration. FIG. 52 depicts a parallel arrangement of propeller assemblies in a four motor-wing configuration. FIG. 53 depicts a diagonal arrangement of propeller assemblies in a six motor-wing configuration. FIG. 54 depicts a parallel arrangement of propeller assemblies in a six-motor-wing configuration. Note: line 2210 represents assemblies rotating in the same direction. Additional arrangements include: more than five propellers, more than six propeller assemblies, and alternating clockwise and counter-clockwise propeller assemblies arranged radially.

Quill Assemblies:

The quill assembly accommodates a number of propulsion systems and landing gear assemblies.

Drawing 23:

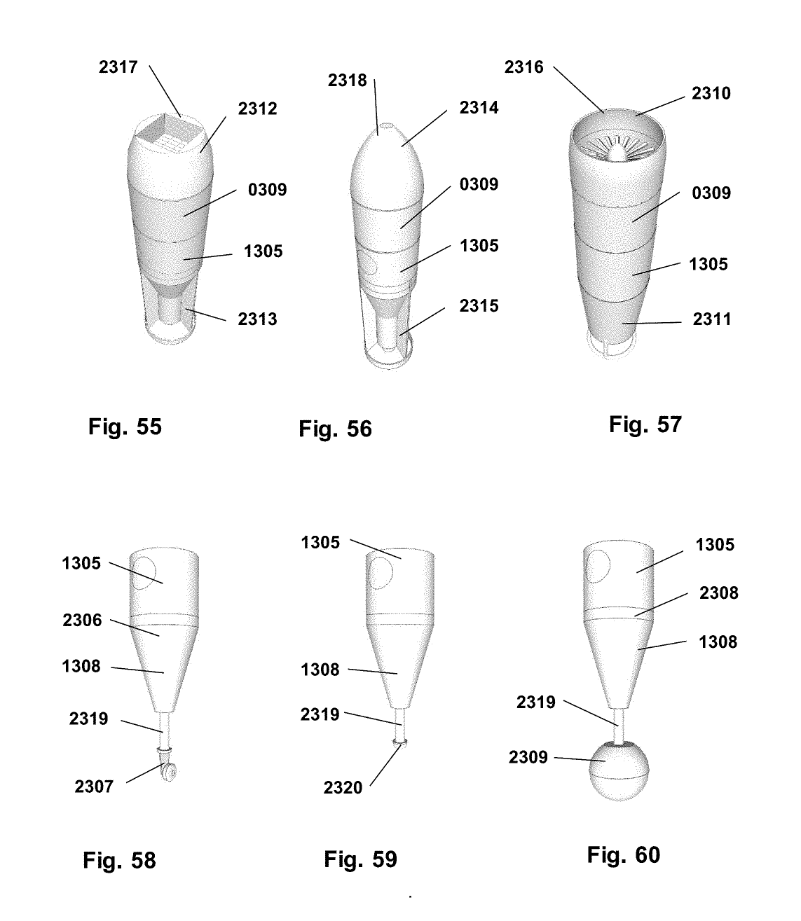

Illustrates the types of quill and landing gear assemblies. FIG. 30 and FIG. 31 depict propeller propulsion quill assemblies. FIG. 55 depicts a pulse-jet quill assembly. FIG. 56 depicts a rocket quill assembly. FIG. 57 depicts a turbine quill assembly. FIG. 58 depicts a wheel landing gear assembly. FIG. 59 depicts a pad landing gear assembly and FIG. 60 depicts a ball landing gear assembly. U.S. Pat. No. 8,083,494 B2.

Hybrid Configurations:

The MGA accommodates a number of propulsion systems for various hybrid configuration arrangements.

Drawing 24:

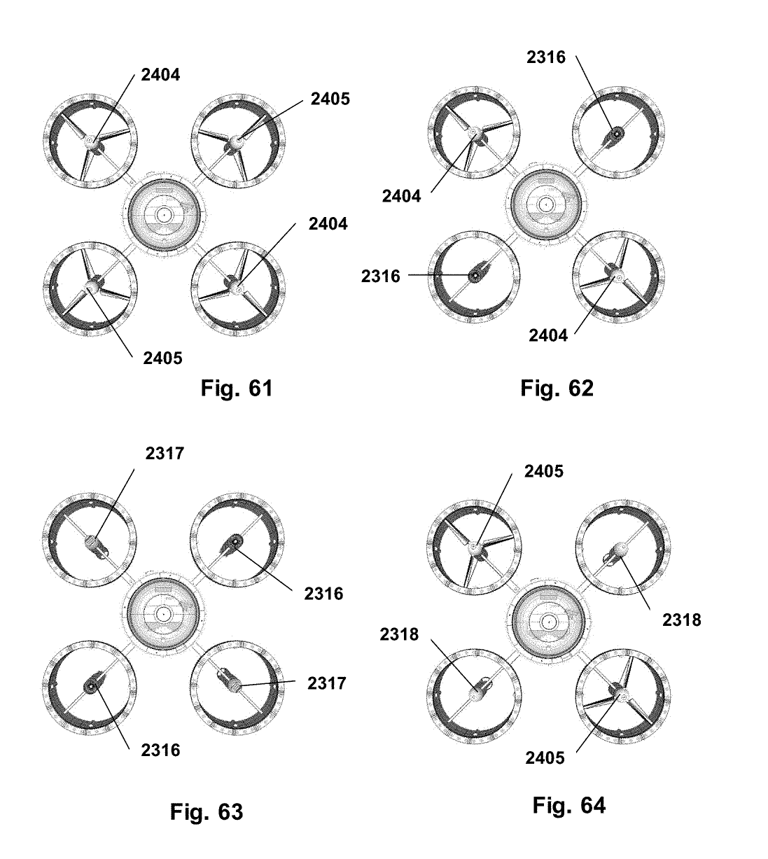

Illustrates hybrid motor-wing arrangements. FIG. 61 depicts a propeller propulsion petroleum powered quill assembly and a propeller propulsion electric powered quill assembly hybrid configuration arrangement. FIG. 62 depicts a propeller propulsion petroleum powered quill assembly and a turbine quill assembly hybrid configuration arrangement. FIG. 63 depicts a turbine quill assembly and pulse-jet quill assembly hybrid configuration arrangement and FIG. 64 depicts a propeller propulsion electric powered quill assembly and a rocket quill assembly hybrid configuration arrangement. Additional hybrid configuration arrangements are possible.

MGAs:

The MGA accommodates a number of cockpit, airframe and motor-wing apparatuses in multiple configurations.

Drawings 25 and 26:

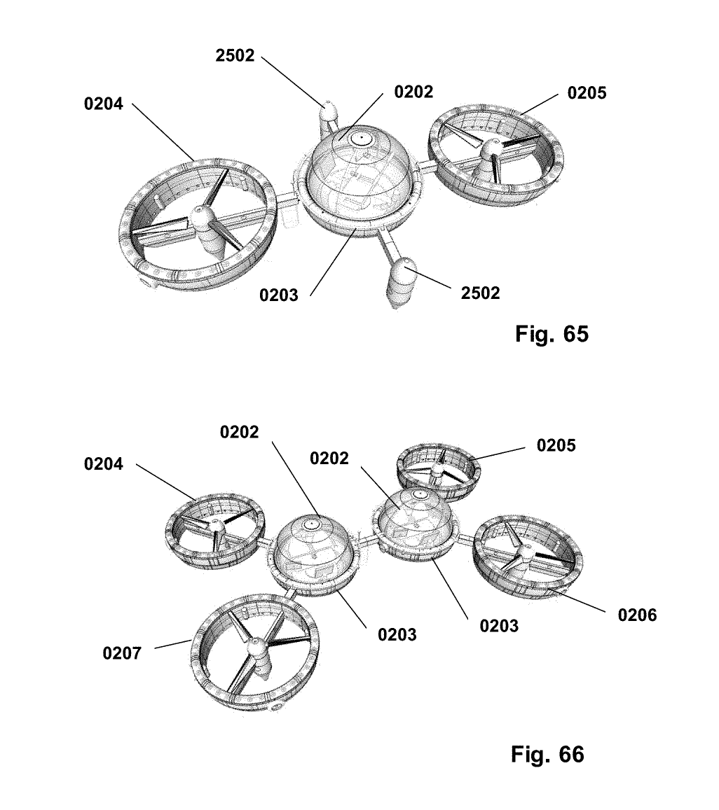

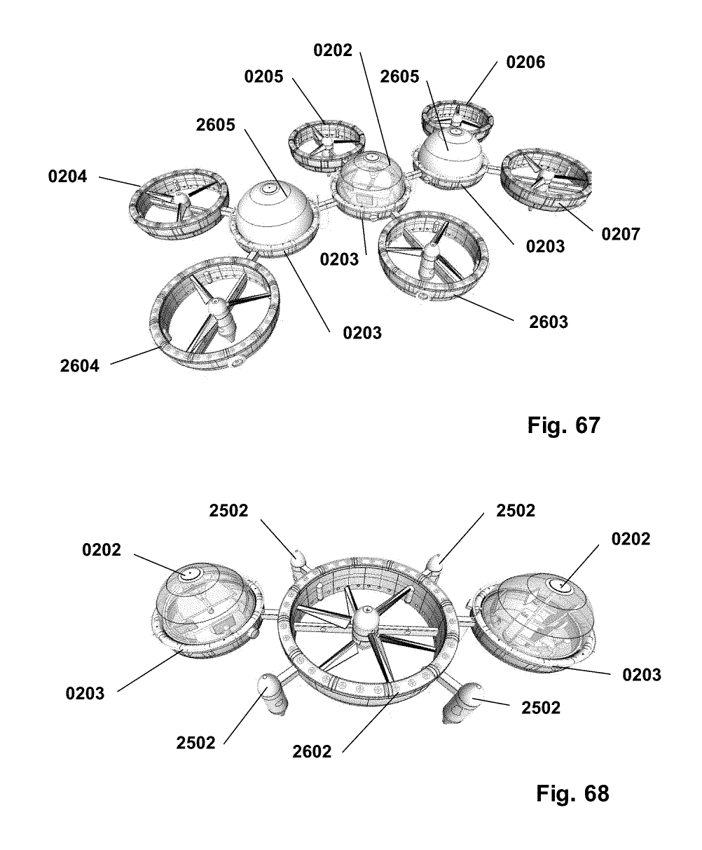

Illustrate MGA configurations. FIG. 65 depicts one cockpit apparatus, one airframe apparatus and two motor-wing apparatuses and two non-powered quill assemblies. FIG. 66 depicts two cockpit apparatuses, two airframe apparatuses and four motor-wing apparatuses. FIG. 67 depicts one cockpit apparatus, two cargo container apparatuses, three airframe apparatuses and six motor-wing apparatuses. FIG. 68 depicts two cockpit apparatuses, two airframe apparatuses, four non-powered quill assemblies and one motor-wing apparatus with a counter-rotating propeller quill. Additional MGA configurations are possible.

Method of Control:

The MGA is controlled by the pilot using the fly-by-light control system or from a remote control station.

Remote Control:

The MGA carries a radio/transponder for communications and receiving commands remotely.

Drawing 27:

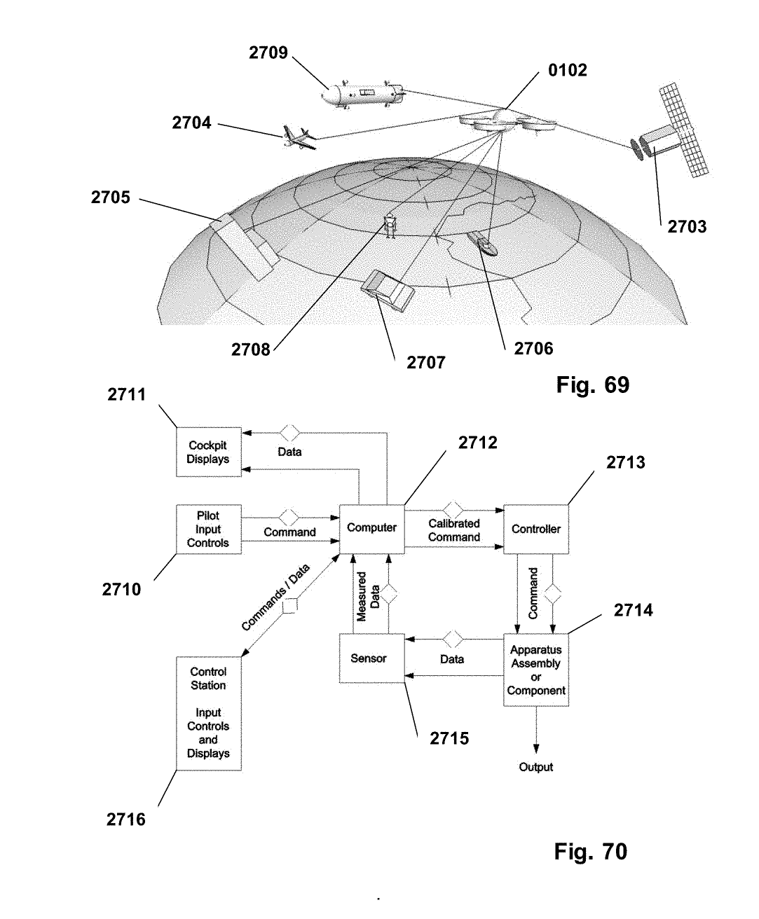

Illustrates a view of control stations locations and the diagram of the fly-by-light wireless control system. FIG. 69 depicts signals sent and received from control stations located on the land, sea, air, and space. Control stations include: MGA 0102, satellite 2703, aerial vehicle 2704, building 2705, waterborne craft 2706, automobile 2707, person 2708, and MGA fleet carrier 2709.

Onboard Control:

The pilot uses conductive wire and wireless control systems to control and maneuver the MGA. The conductive wire system uses an electronic interface. The wireless system replaces some of the conductive wire electronic interface with a wireless LED electronic interface.

Fly-by-Light Control:

FIG. 70 depicts the logic diagram of the fly-by-light wireless control system. It high lights the possible combinations of the onboard conductive wire and wireless communication systems. The pilot input controllers and machine controllers, and their locations, are illustrated and described. They comprise the fly-by light control system. The direction of data and telemetry flow is depicted by leader lines and arrows. Conductive wire control systems are depicted by continuous leader lines and wireless systems are depicted by broken leader lines. Commands made by the pilot via input controls 2710 and the output is shown on cockpit displays 2711 via computer system 2712. The computer system 2712 analyzes and calibrates the commands. The calibrated commands are then transmitted to controller 2713. The controller transmits those commands to apparatuses, assemblies or components 2714 for action, to achieve the desired output. Data is received and measured by sensor 2715. Measured data is sent to computer system 2712. The computer system 2712 analyzes the measured data and may send additional commands to controller 2713 for further action, to achieve the desired output. The computer system 2712 sends the output results to cockpit displays 2711. Sensor 2715 includes measuring instruments: thermometer, accelerometer, gyroscope, counter, tachometer, altimeter, compass, power meter and power level. Each apparatus 0202, 0203, 0204, 0205, 0206 and 0207 incorporates a computer system capable of flying and navigating the MGA. The MGA's computer systems are ranked. The master computer/navigation system 0515 is located in the seat platform assembly 0404. Other ranked computer systems are located throughout the MGA. Computer systems are ranked in hierarchical order with the master computer/navigation system 0515 located in the cockpit apparatus 0202. The ranking order and their locations are as follows: airframe 0203, motor-wing no.1 0204, motor-wing no.2 0205, motor-wing no.3 0206 and motor-wing no.4 0207. In the event of a failure of the master computer/navigation system the next in rank computer system automatically takes control of the MGA.

Intelligent Flight Control:

The intelligent flight control system allows the MGA to perform functions with or without the pilot's input. The intelligent flight control system is used to automatically stabilize the MGA and prevent the operation of the MGA outside its performance envelop. The MGA uses an intelligent flight control system to compensate for MGA damage during flight. It automatically compensates for loss of engines, loss of flight surfaces or other avionic systems. When docking, the intelligent flight control system of one MGA is transferred to the other. The connected MGAs act as one apparatus.

Other Methods:

The MGA uses radio frequency or infrared light communications as the onboard wireless control system.

Method of Piloting:

The pilot uses controllers and displays to interface with the computer system to control and maneuver the MGA. The pilot may elect to operate the MGA in automatic or manual mode. FIG. 71 depicts the pilot interface flight control diagram. It includes: startup, MGA flight controls and gimbal assembly controls.

Drawing 28:

Illustrates the pilot interface flight controls. Drawing 29: Illustrates launch, vertical flight, hovering flight, forward flight and horizontal flight. Drawing 30: Illustrates maneuvers in horizontal flight.

Startup Mode:

The pilot initiates startup by pressing power button 1704. The master computer/navigation system 0515 activates and requests the pilot and the vehicle identification. The MGA will not operate until the pilot's license is verified to be valid and the pilot is an authorized operator of the MGA. After identification authentication the computer/navigation system 0515 powers up the apparatuses, assemblies and components. It conducts a systems check to verify the MGA is cleared for flight operations. The computer system requests a flight plan. The pilot selects the computer operating sub-window 1611 and calls up the road and street maps. The pilot selects the destination and the master computer/navigation system 0515 automatically files a flight plan to the central control having jurisdiction of the airspace. The flight plan may be altered during flight.

MGA Automatic Mode:

The MGA automatic modes include: autopilot mode, touch-and-go mode and flight transition mode.

Autopilot Mode:

By pressing the autopilot button 1510 during flight, the MGA will continue on course according to the flight plan.

Touch-and-Go Mode:

By pressing the touch-and-go button 1512 while on the ground, the MGA will automatically launch, follow the flight plan and land at the destination.

Flight Transition Mode:

By pressing the flight transition button 1509 during flight, the MGA will automatically transition in and out of forward and horizontal flight.

MGA Manual Mode:

The MGA manual mode includes: launch mode, vertical flight mode, hovering flight mode, docking mode, forward flight mode, horizontal flight mode and air breaking mode.

Launch Mode:

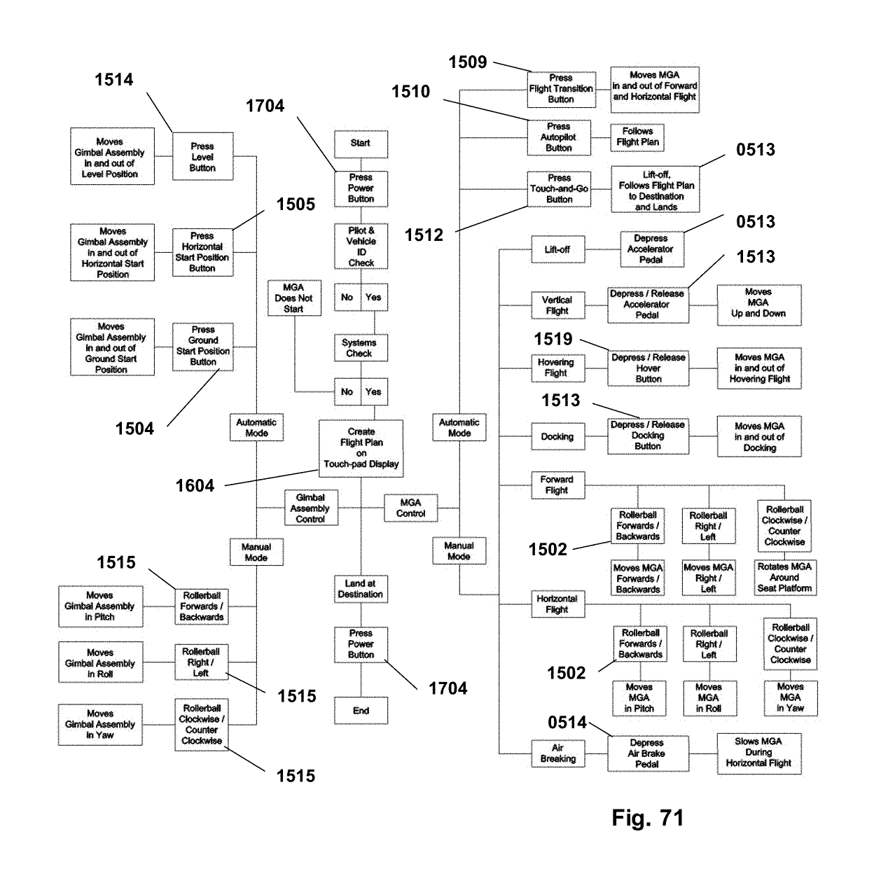

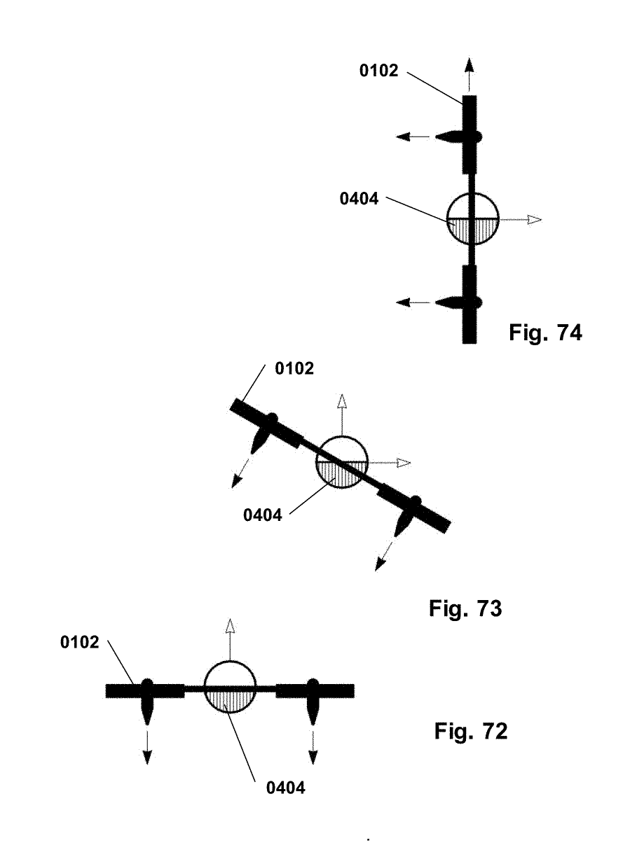

is engaged by depressing accelerator pedal 0513. Motor-wings 0204, 0205, 0206 and 0207 increase their speed providing thrust to launch the MGA off the ground as depicted in FIG. 72.

Vertical Flight Mode:

is engaged by depressing and releasing accelerator pedal 0513. The MGA will move up and down as depicted in FIG. 72.

Hovering Flight Mode:

is engaged by pushing hovering button 1519 the MGA will move in and out of hovering flight as depicted in FIG. 72.

Docking Mode:

is engaged by pressing and releasing docking button 1513, the MGA will engage and disengage electromagnet 1204 associated with male docking assembly 1004 and female docking assembly 1005 for contact formation as depicted in FIG. 118.

Forward Flight Mode:

is engaged by moving right hand rollerball 1502 forwards or backwards, the MGA will correspondingly tilt, moving it forwards or backwards as depicted in FIG. 73; by moving 1502 sideways, left or right, the MGA will correspondingly tilt, moving it right or left as depicted in FIG. 73; by rotating 1502 clockwise or counter-clockwise, the MGA will correspondingly rotate around seat platform assembly 0404.

Horizontal Flight Mode:

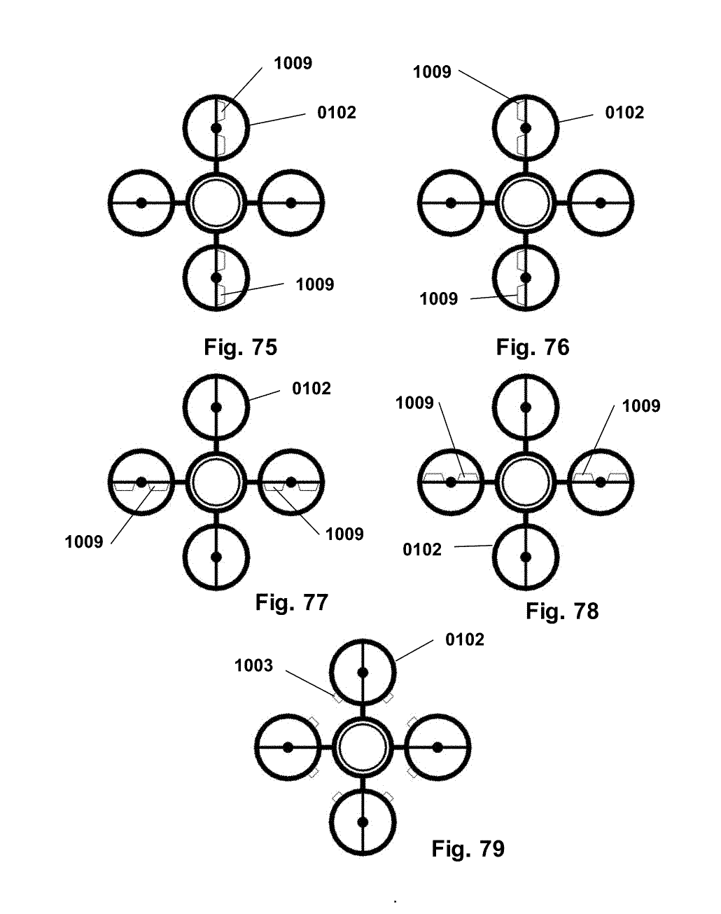

While transitioning from forward flight to horizontal flight, as depicted in FIG. 74, horizontal flight mode is automatically engaged. By moving right hand rollerball 1502 forwards or backwards, ailerons 1009 will correspondingly deploy moving the MGA up or down in pitch as depicted in FIGS. 77 and 78 respectively; by moving 1502 sideways, left or right, ailerons 1009 will correspondingly deploy turning the MGA left or right in roll as depicted in FIGS. 75 and 76 respectively.

Air Braking Mode:

is engaged by depressing air brake 0514, the MGA will deploy gills 1003 slowing it down as depicted in FIG. 79.

Gimbal Assembly Automatic Mode:

The Gimbal assembly automatic mode includes: level position mode, horizontal flight start position mode and ground start position mode.

Level Position Mode:

is engaged by pressing level button 1514, seat platform assembly 0404 will move in and out of the position level to the ground.

Horizontal Flight Start Position Mode:

is engaged by pressing horizontal flight start position button 1505, seat platform assembly 0404 will move in and out of the horizontal flight position as depicted in FIG. 17.

Ground Start Position Mode:

is engaged by pressing ground start position button 1504, seat platform assembly 0404 will move in and out of the ground start position as depicted in FIG. 16.

Gimbal Assembly Manual Mode:

The gimbal assembly manual mode includes: pitch mode, roll mode and yaw mode.

Pitch Mode:

is engaged by moving left hand rollerball 1515 forwards or backwards, seat platform assembly 0404 correspondingly moves forwards or backwards in pitch as depicted in FIG. 12.

Roll Mode:

is engaged by moving 1515 left or right, seat platform assembly 0404 correspondingly moves left or right in roll as depicted in FIG. 12.

Yaw Mode:

is engaged by rotating 1515 clockwise or counter-clockwise, seat platform assembly 0404 correspondingly rotates clockwise or counter-clockwise as depicted in FIG. 12.

Method of Visual Light Signaling:

The light-bracelet assembly illuminates in different colors and different flashing sequences. It operates in several different light signal modes concurrently. The light bracelet assembly has a number of light signal modes: Air-shelf signal mode, tilt signal mode, ascent/descent signal mode, turn signal mode, rotate signal mode, docking signal mode, land signal mode, launch signal mode, warning signal mode and emergency signal mode.

Drawings 31 and 32:

Illustrate light-bracelet signal modes.

Air-Shelf Signal Mode:

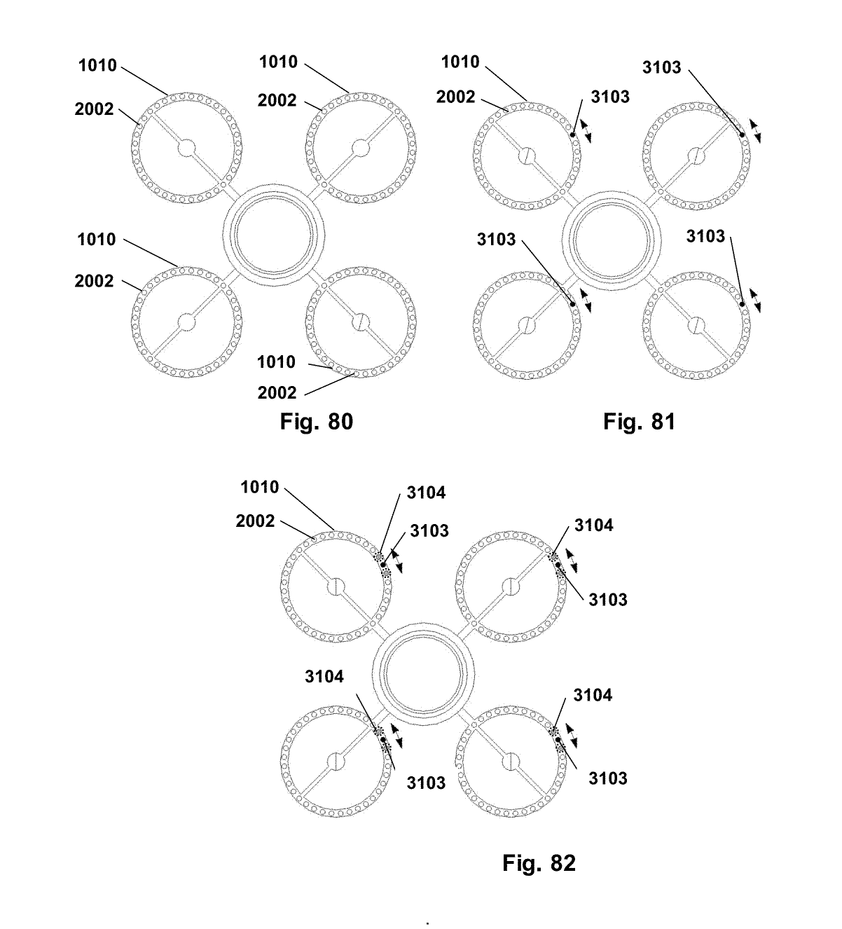

FIG. 80 depicts air-shelf signal mode. Air-shelf signal mode functions concurrently with other signal modes. All LED light modules 2002 within light bracelet assembly 1010 illuminate in the color of the air-shelf, within air column 3302, the MGA is traveling in.

Tilt Signal Mode:

FIG. 81 depicts tilt signal mode. Tilt signal mode functions concurrently with air-shelf signal mode and ascent/descent signal mode. Light-bracelet assembly 1010 signals the tilt of motor-wing apparatuses 0204, 0205, 0206 and 0207, thus the direction the MGA is heading. Tilt signal mode works under the principles of a level. It can be understood with the example of a clear plastic tube bended and connected to form a bracelet, and a ball placed inside. When the bracelet is tilted in space, the ball will move and come to rest at the lowest point. If the bracelet is constantly tilting along different axes, the ball will stay in motion. Tilt signal mode works similarly using visible lights. Light bracelet assembly 1010 replaces the plastic tube and light-ball 3103 replaces the ball. Light-ball 3103 illuminates in a unique color when tilt signal mode is engaged.

Ascent/Descent Signal Mode:

FIG. 82 depicts ascent/descent signal mode. It functions concurrently with air-shelf signal mode, turn signal mode and tilt signal mode. It signals the MGA's ascent or descent through air-shelves, within air column 3302. Here, on either side of light-ball 3103, two adjacent light modules 2002 illuminate to form air-shelf light-ball set 3104. Air-shelf light-ball set 3104 illuminates in the color of the air-shelf, within air column 3302 the MGA is traveling to. They remain alongside light-ball 3103 as it operates.

Turn Signal Mode:

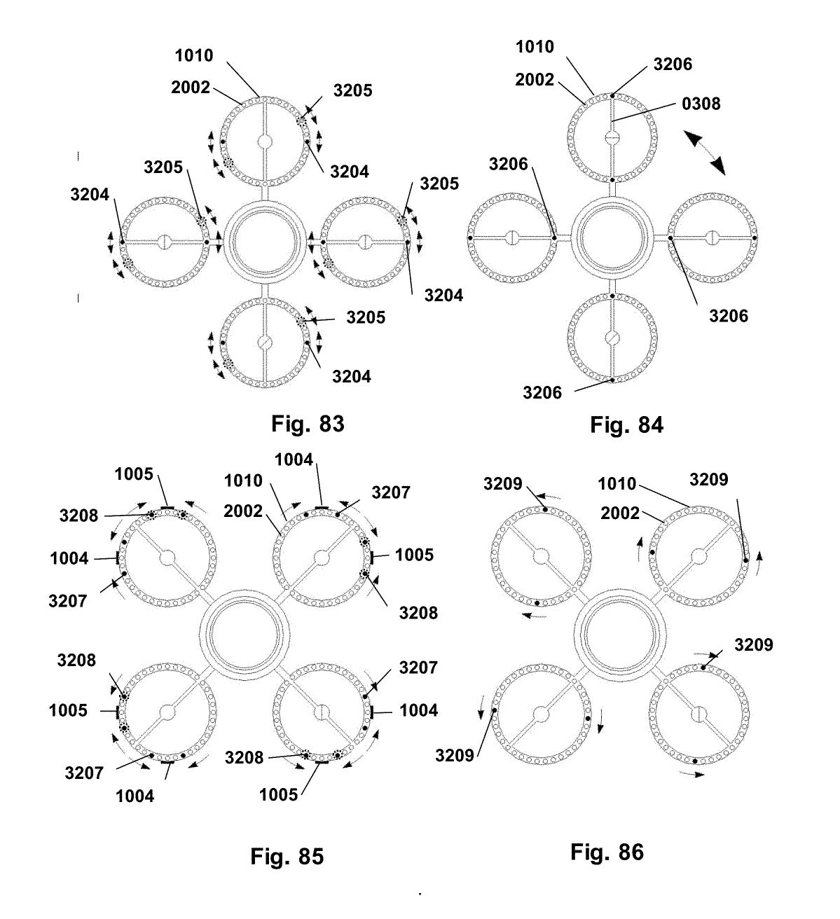

FIG. 83 depicts turn signal mode. Turn signal mode functions automatically in horizontal flight and concurrently with air-shelf signal mode and ascent/descent signal mode. Turn signal mode functions under the principles of a turn coordinator displaying the roll of the MGA relative to the horizon. Two sets of different and unique colored LED light modules 2002 form a visual light turn coordinator. Each LED light module 2002 within each set are opposite of one another. The first light-ball set, horizon light-ball set 3204 remains level with the horizon. It illuminates in a unique color. When the motor-wing apparatuses 0204, 0205, 0206 and 0207 are flying level to the horizon, the two light-ball sets 3204 and 3205 merge into one light-ball set and illuminates in a unique color.

Rotate Signal Mode:

FIG. 84 depicts rotate signal mode. Rotate signal mode operates in vertical, hovering, forward and horizontal flight and functions concurrently with air-shelf signal mode, tilt signal mode, ascent/descent signal mode and turn signal mode. It activates when motor-wing apparatuses 0204, 0205, 0206 and 0207 rotate around seat platform assembly 0404. Rotate light-ball set 3206 aligns with strut 0308. 3206 illuminates and flashes in a unique color.

Docking Signal Mode:

FIG. 85 depicts docking signal mode. Docking signal mode is engaged when the pilot presses docking button 1513 during docking procedures. Docking signal mode includes two light-ball sets: male light-ball set 3207 and female light-ball set 3208. 3207 and 3208 travel along opposite paths in light-bracelet assembly 1010 starting at opposite sides of their respective docking assemblies 1004 and 1005. They illuminate in a unique color. Each set merges into one light-ball 3103 at docking assemblies 1004 and 1005 and flash multiple times, the sequence repeats. The number of docking light-ball sets 3207 and 3208 activated is directly related to the number of docking assemblies, 1004 and 1005, engaged in contact formation 4004. When docking has occurred, light-ball sets 3207 and 3208 remain at docking assemblies 1004 and 1005 respective locations and flash constantly in a unique color.

Launch and Land Signal Modes:

FIG. 86 depicts launch and land signal modes. They activate automatically when the MGA is cleared for flight operations on the ground and when MGA's warning shield 3406 contacts landing-zone warning shield 3406 on landing approach. It is also activated automatically in the absents of landing pad 3410 as the MGA approaches ground surface 3309. In land signal mode, light bracelet assembly 1010 illuminates in a unique color; and launch/land light-ball set 3209 illuminates in a unique color. Launch/land light-ball set 3209 includes two LED light modules 2002. Each start at opposite sides to one another and travel on a path along the light-bracelet 1010 in opposite directions to one another. The rate of speed they travel increases the closer they come to land. At touch down the light-bracelet 1010 illuminates in a unique color. The reverse order occurs during launch procedures.

Warning Signal Mode:

Activates automatically when the MGA contacts static or dynamic warning shields 3406. Light-bracelet 1010 illuminates and flashes in a unique color when warning signal mode is engaged.

Emergency Signal Mode:

Activates automatically when the MGA is under a flight emergency. Light-bracelet 1010 illuminates and flashes in a unique color when emergency signal mode is engaged.

Method of Electronic Mapping of Airspace (EMA):

This method organizes airspace for the safe passage of aerial vehicles. It maps: the air column, ground surface, static and dynamic objects and their corresponding shields. In this method, nodes in space are given coordinates using the GPS. The nodes can be arranged to define facets that in turn can be combined and arranged to define three dimensional geometries in space. The shapes and sizes of air-shelves, ground zones, static shields and dynamic shields are described and defined by this geometry. They vary according to the areas and objects they surround, and the movement of those objects through space. The coordinates for ground and aerial obstructions and their associated shields are registered on the EMA. Static obstructions are surveyed. Dynamic objects' positions are tracked using cellular communications. Natural dynamic obstructions are tracked using radar. Their shields are established by the weather authorities and inputted into the EMA. The EMA is continuously updated. It is accessed by pilots through the internet via cellular communications. Reference Other Publications: Aeronautical Information Manual.

Drawing 33:

Illustrates examples of the air column and ground surface.

Air Column:

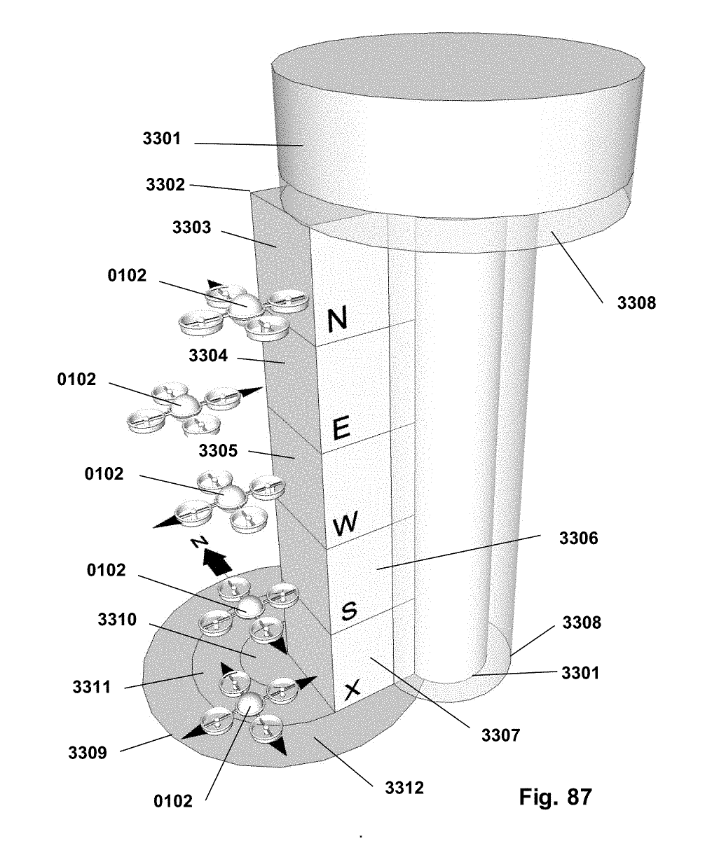

FIG. 87 depicts the restricted airspace, unrestricted airspace, warning shields, ground zones and air-shelves within the air column. Unrestricted airspace is established by the authorities have jurisdiction over air traffic. It includes: air-shelf N, air-shelf E, air-shelf W, air-shelf S and air shelf X. Air-shelves within the air column can be remembered using the acronym “NEWSX”: The “N” stands for north, the “E” for east, the “W” for west, the “S” for south and the “X” for any direction. Each air-zone's floor and ceiling height vary; and is directly dependent and equally proportional to the height limits established by unrestricted airspace in a given area.

Air-Shelf N:

Air-shelf N 3303 occupies the air-space above air-shelf E 3304. Its ceiling height is defined by the ceiling height limit of unrestricted airspace less the height of airspace warning shield 3308. It is reserved for aerial vehicles heading in a northerly direction. It is assigned a unique color that is displayed on light bracelet 1010 while flying through it.

Air-Shelf E:

Air-shelf E: 3304 occupies the air space above air-shelf W 3305. It is reserved for aerial vehicles heading in an easterly direction. It is assigned a unique color that is displayed on light-bracelet 1010 while flying through it.

Air-Shelf W:

Air-shelf W 3305 occupies the air-space above air-shelf S 3306. It is reserved for aerial vehicles heading in a westerly direction. It is assigned a unique color that is displayed on light-bracelet 1010 while flying through it.

Air-Shelf S:

Air-shelf S 3306 occupies the air-space above air-shelf X 3307. It is reserved for aerial vehicles heading in a southerly direction. It is assigned a unique color that is displayed on light-bracelet 1010 while flying through it.

Air-Shelf X:

Air-shelf X 3307 occupies the air space contiguous to ground surface 3309. It is reserved for aerial vehicles flying in any direction. It is assigned a unique color that is displayed on light-bracelet 1010 while flying through it.

Ground Surface:

FIG. 87 depicts the ground zones within ground surface 3309. Aerial vehicle ground speed while flying over certain ground zones may be restricted. Ground zones include: ground zone 1 3310, ground zone 2 3311 and ground zone 3 3312.

Ground Zone 1:

Ground zone 1 3310 exists over densely populated metropolitan areas.

Ground Zone 2:

Ground zone 2 3311 exists outside of ground zone 1 3310 over less densely populated areas, suburban areas.

Ground Zone 3:

Ground zone 3 3312 exists outside ground-zone 2 3311 and ground zone 1 3310.

Restricted Airspace:

FIG. 87; Restricted airspace 3301 is a static manmade ground and air obstruction established by the authorities having jurisdiction over air traffic.

Airspace Warning Shield:

FIG. 87; Airspace warning shield 3308 is contiguous to and surrounds restricted airspace 3301.

Static Shields:

Static shields include warning shields and action shields surrounding manmade and natural ground obstructions. Their shape and size vary, and are dependent on the type of obstruction.

Drawing 34:

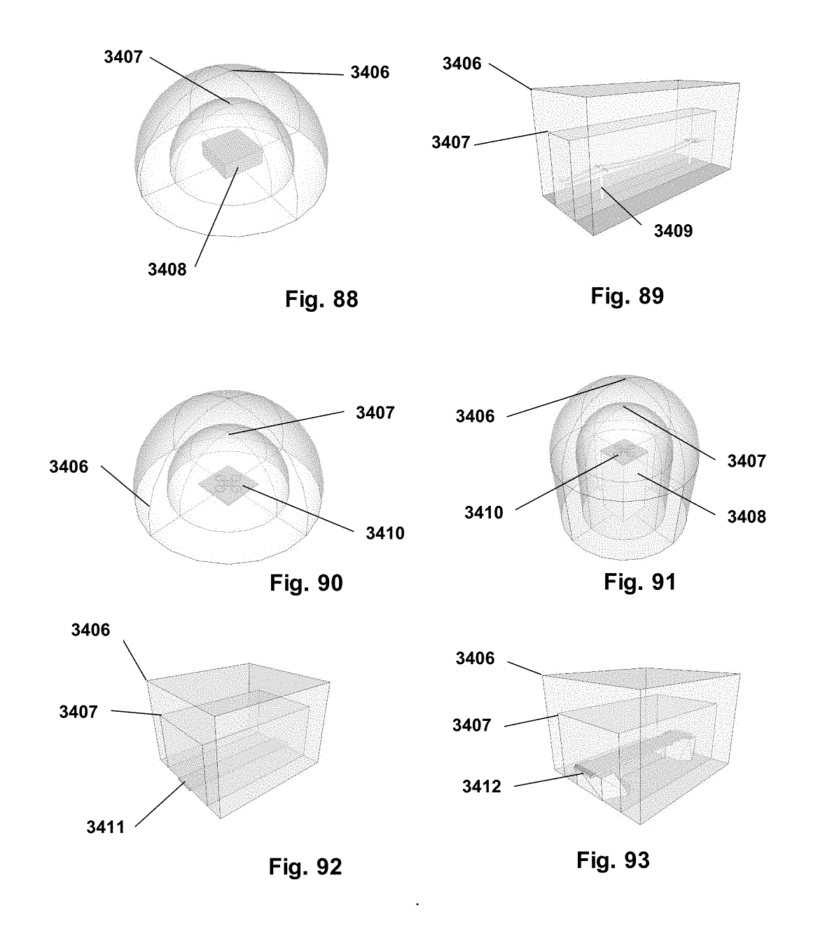

Illustrates examples of warning and action shields surrounding static manmade objects. FIG. 88 depicts warning and action shields surrounding structure 3408. FIG. 89 depicts warning and action shields surrounding power line 3402. FIG. 90 depicts warning and action shields surrounding landing pad 3410. FIG. 91 depicts warning and action shields surrounding landing pad 3410 atop structure 3408. FIG. 92 depicts warning and action shields surrounding road way 3411. FIG. 93 depicts warning and action shields surrounding bridge 3412.

Drawing 35:

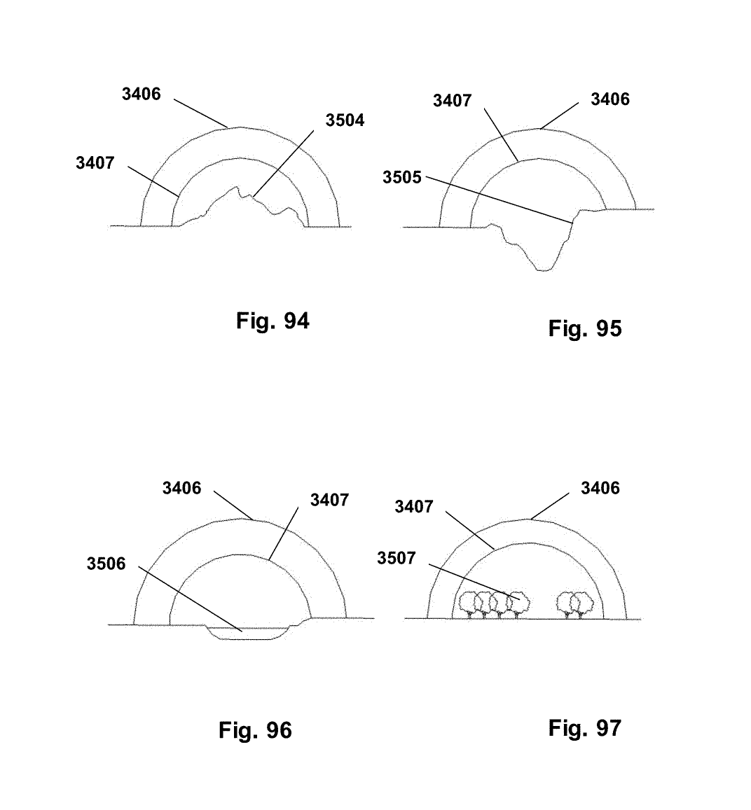

Illustrates examples of warning and action shields surrounding static natural objects. FIG. 94 depicts warning and action shields surrounding a mountain range, FIG. 95 depicts warning and action shields surrounding a canyon, FIG. 96 depicts warning and action shields surrounding a waterway, FIG. 97 depicts warning and action shields surrounding a forest.

Dynamic Shields:

Dynamic shields include warning shields and action shields surrounding manmade and natural obstructions.

Drawing 36:

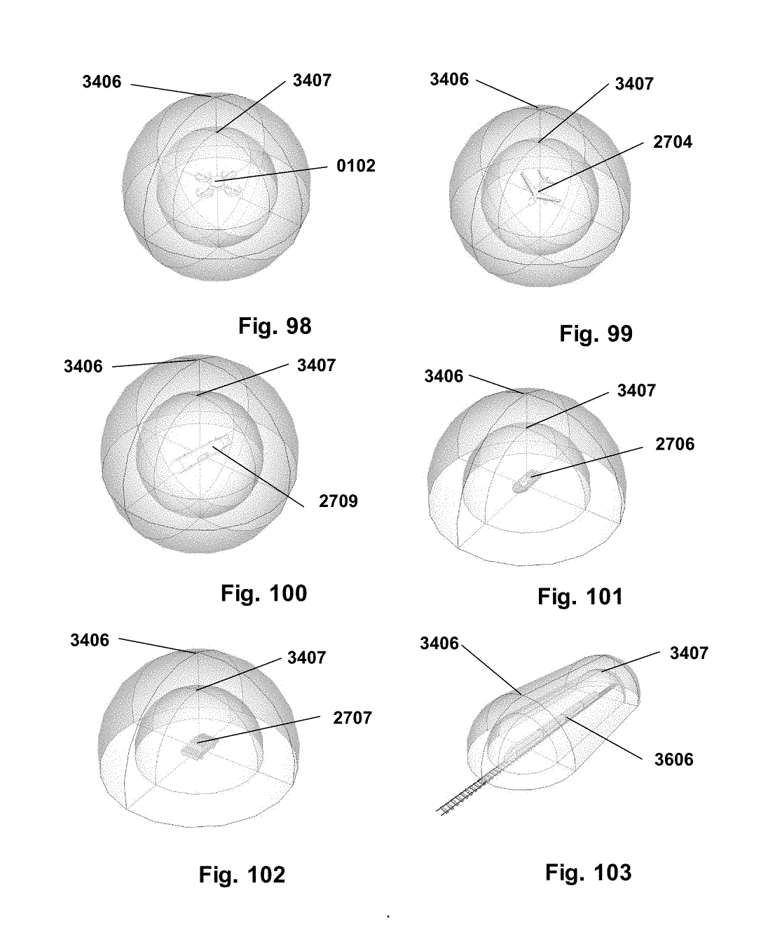

Illustrates examples of warning and action shields surrounding dynamic manmade objects. FIG. 98 depicts warning and action shields surrounding MGA 0102. FIG. 99 depicts warning and action shields surrounding aerial vehicle 2704. FIG. 100 depicts warning and action shields surrounding MGA carrier 2709. FIG. 101 depicts warning and action shields surrounding waterborne craft 2706. FIG. 102 depicts warning and action shields surrounding automobile 2707. FIG. 103 depicts warning and action shields surrounding train 3606.

Drawing 37:

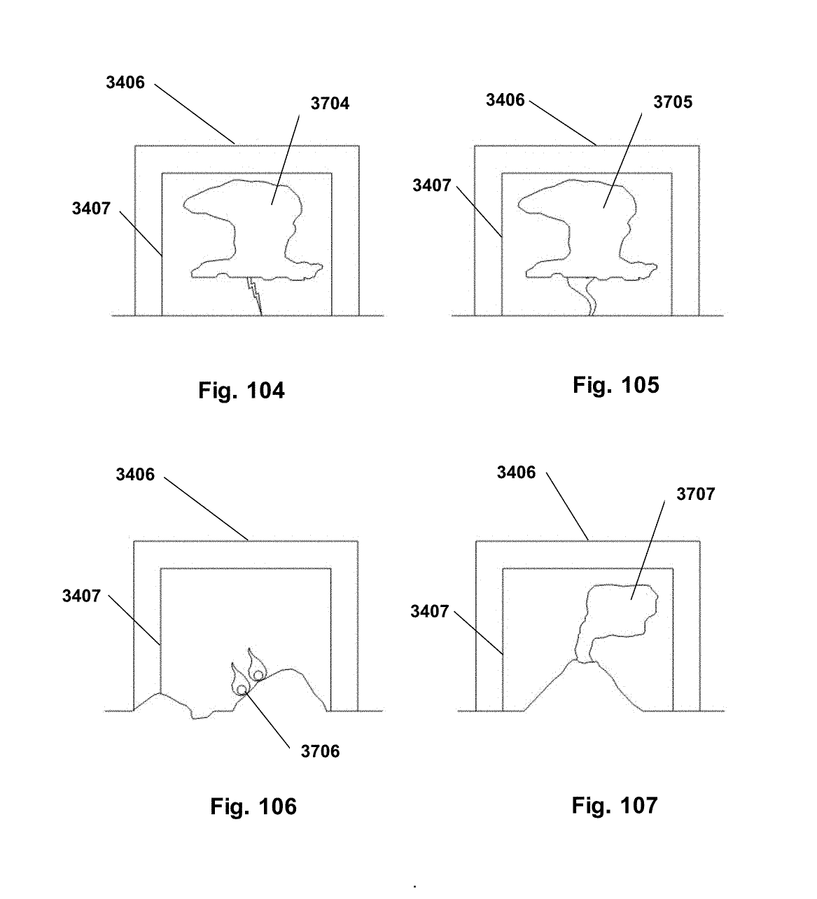

Illustrates examples of warning and action shields surrounding dynamic natural objects. FIG. 104 depicts warning and action shields surrounding thunderstorm 3704. FIG. 105 depicts warning and action shields surrounding tornado 3705. FIG. 106 depicts warning and action shields surrounding fire 3706. FIG. 107 depicts warning and action shields surrounding volcano 3707.

Method of Navigation:

Drawing 38:

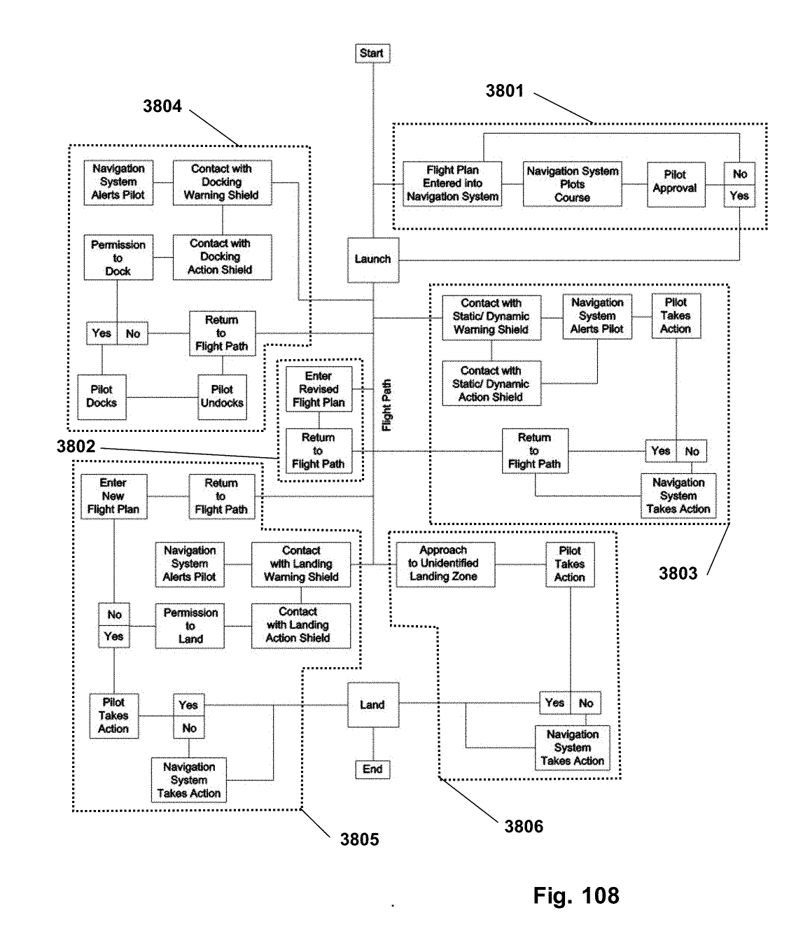

Illustrates the method of navigation. There are two modes of navigation, automatic and manual. The MGA will automatically respond and take action to avoid collisions when in flight. Whether flying in automatic mode or manual mode the MGA will automatically alert the pilot, through the navigation system, and take action to avoid colliding into EMA mapped objects. FIG. 108 depicts the launch, flight and land sequences of manual and automatic navigation modes. They include: startup mode, flight plan revision mode, shield contact mode, docking mode, identified landing pad mode and unidentified landing zone mode.

Manual Navigation Mode:

Manual navigation mode assists the pilot to: orient themselves of their current location and heading, negotiate through air space to destinations, track other aircraft in proximity, avoid other aircraft and adhere to regulations for airspace. The main navigation window 1705 indicates where the MGA 0102, other MGAs 1720 and other aircraft 1721 are in airspace. The MGA icon 1718 within view scale/compass layer 1716 remains fixed in the center of the main navigation window 1705. The other layers of information 1707, 1708, 1709, 1710, 1711, 1712, 1713, 1714 and 1715 are registered to 1705 at the same scale. The pilot may change scales (e.g., from a radius 1 mile out to a 5 miles out). MGA icon 1718 within 1707 and tracking trail 1717 illuminate in the color of the air-shelf the MGA is flying in and the heading it is on. MGA icon 1720 will display its call sign, for identification and communication purposes. Tracking trail 1717 is displayed as a line segment that increases in length as the aircraft flies through air space. 1717 illuminates in the color of the airspace it is flying in. In the event that the aircraft has passed through multiple air-shelves, tracking trail 1717 will illuminate in multiple colors corresponding to the air-shelves they have passed through.

Automatic Navigation Mode:

Automatic navigation mode includes: startup mode, touch-and-go mode, autopilot mode, flight plan revision mode, shield contact mode, docking mode, identified landing pad mode and unidentified landing zone mode.

Startup Mode:

Startup mode 3801 is engaged when the pilot enters a flight plan into the master computer/navigation system 0515. 0515 plots a course that is displayed on 1705 and 1607. When the pilot approves the flight plan, they enter it into 0515. If the pilot does not approve the flight plan they reenter a new flight plan. The flight plan is sent to the central control station and registered on the EMA. The MGA is prepared to launch.

Touch-and-Go Mode:

Touch-and-go mode is engaged by pressing touch-and go button on the right hand controller after a flight plan has been approved by the pilot. It will automatically launch the MGA, travel through airspace following the approved flight path, avoid EMA mapped obstructions and restricted airspace, and land the MGA at its destination.

Autopilot Mode:

Autopilot mode is engaged when the pilot presses the autopilot button on the right hand controller. It will bring the MGA in line with the approved flight plan and bring the MGA to a point where the MGA's warning shield 3406 makes contact with the static or dynamic warning shield 3406 at its destination.

Flight Plan Revision Mode:

Flight plan revision mode 3802 is engaged during flight when the pilot wishes to alter the flight path or destination. The pilot reenters a flight plan into the master computer/navigation system 0515. 0515 plots a course that is displayed on 1705 and 1607. When the pilot approves the flight plan, they enter it into 0515. The flight plan is sent to the central control station and registered on the EMA. 0515 alters the MGA's course in line with the new flight plan.

Shield Contact Mode:

Shield contact mode 3803 is engaged during flight operations when the MGA's warning shield 3406 contacts another static or dynamic warning shield 3406. The master computer/navigation system 0515 alerts the pilot of the contact through the main navigation window 1705. When the MGA's action shield 3407 contacts the action shield 3407 of another aerial vehicle, the pilot takes action to avoid collision. In the event that the pilot does not take action the master computer/navigation system 0515 will automatically take action to avoid collision. The pilot or 0515 will return the MGA to its flight path.

Docking Mode:

Docking mode 3804 is engaged during flight operations when the MGA's warning shield 3406 contacts another MGA's warning shield 3406. The master computer/navigation system 0515 alerts the pilot of the contact through the main navigation window 1705. When the MGA's action shield 3407 contacts the action shield 3407 of another MGA, the initiating pilot requests permission to dock. If permission is granted the initiating pilot takes action and docking procedures commence. If permission is not granted the initiating pilot returns the MGA to its flight path. The pilots agree on the transfer of flight controls to a single master computer/navigation system 0515. Contact formation 4004 is formed. After a period of time, undocking procedures commence and 0515 or the initiating pilot returns the MGA to its flight path.

Identified Landing Pad Mode:

Identified landing pad mode 3805 is engaged during flight operations when the MGA's warning shield 3406 contacts landing pad 3410's warning shield 3406. The master computer/navigation system 0515 alerts the pilot of the contact through the main navigation window 1705. When the MGA's action shield 3407 contacts the action shield 3407 of landing pad 3410 the pilot requests permission to land. The pilot enters a passcode that opens the landing pad for the MGA. If permission is granted the pilot takes action and landing procedures commence. A control station can land the MGA upon pilot's permission. If permission to land is not granted the pilot enters a new flight plan into the master computer/navigation system 0515 and moves the MGA onto its new flight path.

Unidentified Landing Mode:

Unidentified landing mode 3806 is engaged during flight operations when the MGA's warning shield 3406 contacts ground surface 3309. The master computer/navigation system 0515 alerts the pilot of the contact through the main navigation window 1705. When the MGA's action shield 3407 contacts ground surface 3309 the pilot takes action and landing procedures commence. If the pilot does not take action the master computer/navigation system 0515 will land the MGA.

Navigation Window 3D Mode:

Navigation window 3D mode is engaged through the touch-pad display. It takes the layers displayed on the main navigation window 1705 and renders them in three dimensions. The layers include: tracking and orientation layer 1707, airspace and ground zone map layer 1708, satellite image map layer 1709, weather layer 1710, downward camera layer 1711, road and street map layer 1712, destination points and landing pads layer 1713, flight plan/flight course layer 1714, and programmable layer 1715.

### Applications

Flight Applications:

The MGA can conduct a number of flight operations and flight missions. The MGA can launch and land from the ground, water, and static and mobile platforms. Drawing 39: Illustrates the launch and land venues. Drawing 40 and 41: Illustrate flight operations. Drawing 42: Illustrates Flight operation missions.

Flight Operations:

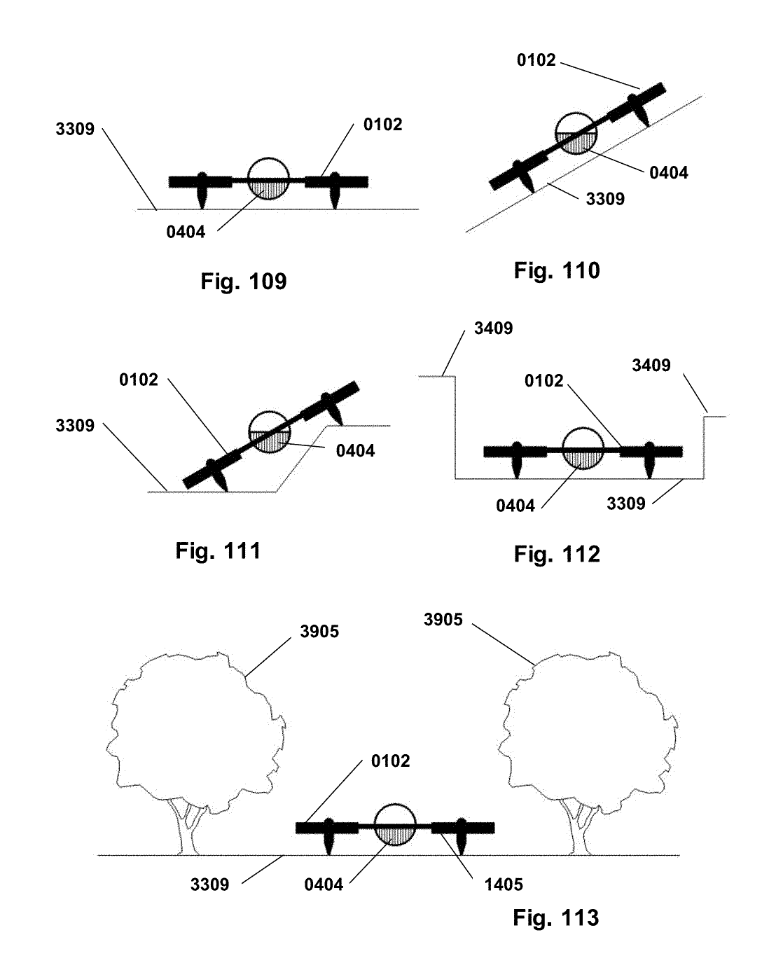

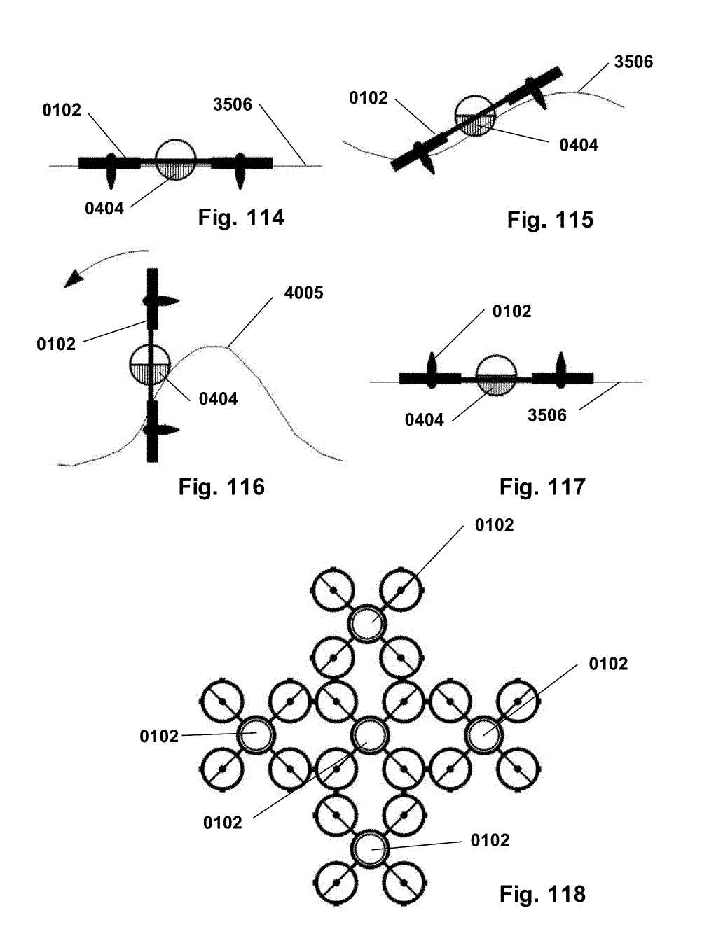

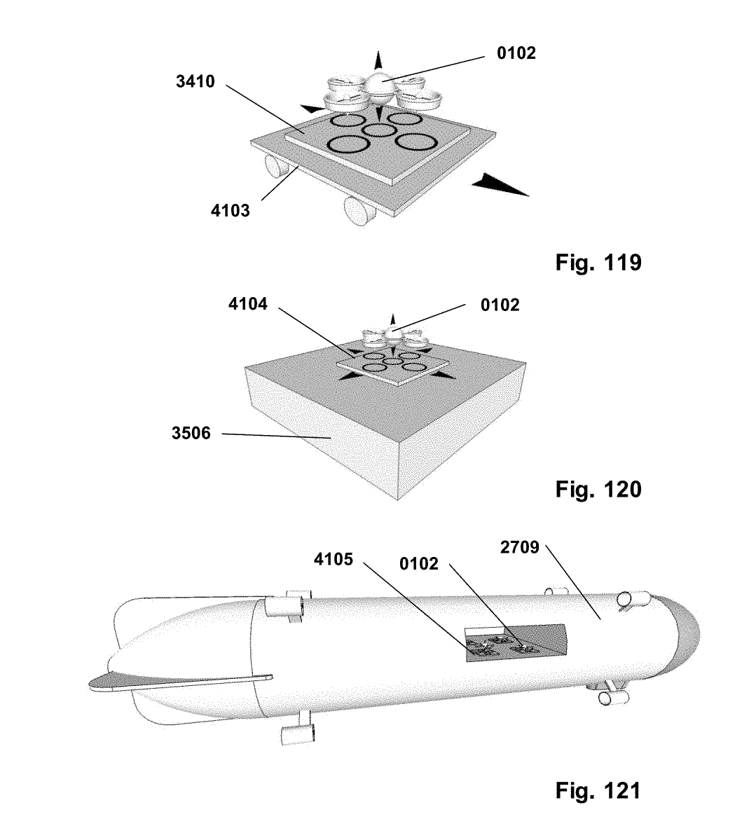

FIG. 109 depicts the MGA 0102 land and launch from flat ground surface 3309. FIG. 110 depicts 0102 land and launch from sloped ground surface 3909. FIG. 111 depicts 0102 land and launch from uneven ground surface 3909. FIG. 112 depicts 0102 land and launch from between structures 3409. FIG. 113 depicts 0102 land and launch from between trees 3905. In this event, 0102 is equipped with lower safety grate assembly 1405. FIG. 114 depicts 0102 land and launch from waterway 3506. FIG. 115 depicts 0102 land, float and launch from trepid waterway 3506. FIG. 116 depicts 0102 overturning on wave 4005. FIG. 117 depicts 0102 overturned and afloat on waterway 3506. Note: seat platform assembly 0404 is in the ground start position. In this event, the MGA acts as a life boat. FIG. 118 depicts 0102 in contact formation with multiple MGAs. FIG. 119 depicts 0102 conducting flight operations off mobile land platform 4103. FIG. 120 depicts 0102 conducting flight operations off mobile waterborne platform 4104. FIG. 121 depicts 0102 conducting flight operations off mobile airborne platform 4105.

Flight Missions:

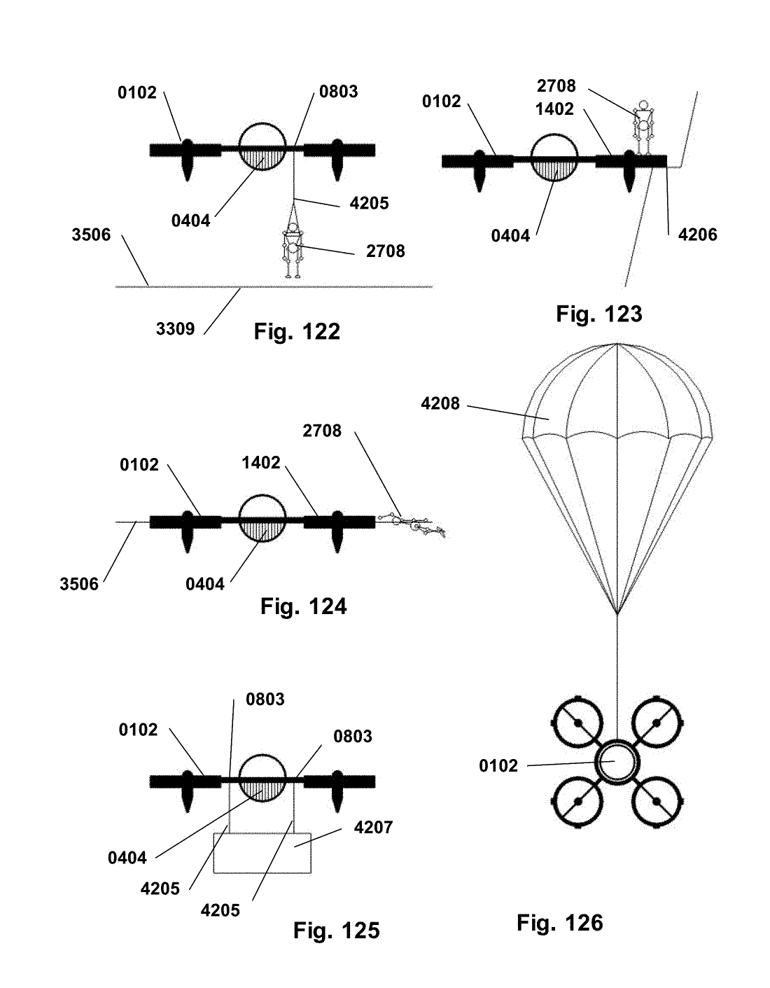

FIG. 122 depicts 0102 in a rescue mission where cable 4205 is lowered, from wench assembly 0803, to flat ground surface 3309 or waterway surface 3506 and lifts person 2708 to safety. FIG. 123 depicts 0102 in a ledge rescue mission where the motor-wing apparatus 0204 touches ledge 4206 and person 2708 climbs onto upper safety grate 1405 to safety. FIG. 124 depicts a rescue mission where 0102 lands on waterway 3506 and person 2708 climbs onto upper safety grate assembly 1405 to safety. FIG. 125 depicts 0102 in a hauling mission where cables 4205, from wench assemblies 0803, are attached to cargo container 4207 and carried to a destination. FIG. 126 depicts 0102 in an in-flight emergency where parachute 4208 is deployed.

Military Applications:

The MGA is a tactical systems platform for weapons, rescue, supply, reconnaissance and surveillance. The MGA works in concert with the MGA carrier in a strategic role.

1. Motor-wing Gimbal Aircraft (MGA): described and illustrated including: a) Structural Frame; b) Cockpit Apparatus; c) Airframe Apparatus; d) Motor-wing Apparatus; e) Pilot Input Controls and Displays System; f) Fuel and Distribution System; g) Power and Distribution System; h) Lighting Systems; i) Camera System; j) Information System; k) Communication System and l) Buoyancy.

2. Method of Manufacturing: described and illustrated including: a) Seat Platform Assemblies; b) Gimbal Assemblies; c) Airframe Modular Panels; d) C-wing Modular Panels; e) Propeller Assemblies; f) Quill Assemblies; g) Hybrid Configurations; and h) MGAs.

3. Method of Control: described and illustrated including: a) Remote Control and b) Onboard Control including: 1. Fly-by-Light Control and 2. Intelligent Flight Control.

4. Method of Piloting: described and illustrated including: a) Startup Mode; b) MGA Automatic Mode including: 1. Autopilot Mode, 2. Touch-and-go Mode, 3. Flight Transition Mode; c) MGA Manual Mode including: 1. Launch Mode; 2. Vertical Flight Mode; 3. Hovering Flight Mode; 4. Docking Mode; 5. Forward Flight Mode; 6. Horizontal Flight Mode and 7. Air Braking Mode; and d) Gimbal Assembly Manual Mode including: 1. Pitch Mode; 2. Roll Mode; 3. Yaw Mode.

5. Method of Visual Light Signaling: described and illustrated including: a) Air-shelf Signal Mode; b) Tilt Signal Mode; c) Ascent/Descent Mode; d) Turn Signal Mode; e) Rotate Signal Mode; f) Docking Signal Mode; g) Launch Signal Mode; h) Land Signal Mode; i) Warning Signal Mode and j) Emergency Signal Mode.

6. Method of Electronic Mapping of Airspace (EMA): described and illustrated including: a) Air Column Air-shelves including: 1. Air-shelf N; 2. Air-shelf E; 3. Air-shelf W; 4. Air-shelf S; 5. Air-shelf X; b) Ground Surface Zones including: 1. Ground Zone 1; 2. Ground Zone 2 and 3. Ground Zone 3; c) Restricted Airspace; d) Airspace Warning Shield; e) Static Warning Shields including: 1. Static Warning Motor-wing Gimbal Aircraft, Methods and Applications Shields Surrounding Manmade Ground Obstructions; 2. Static Warning Shields Surrounding Natural Ground Obstructions; and f) Dynamic Action Shields including: 1. Dynamic Action Shields Surrounding Manmade Objects; 2. Dynamic Action Shields Surrounding Natural Obstructions.

7. Method of Navigation: described and illustrated including: a) Manual Navigation Mode; b) Automatic Navigation Mode including: 1. Startup Mode; 2. Flight Plan Revision Mode; 3. Shield Contact Mode; 4. Docking Mode and 5. Identified Landing Pad Mode; and c) Navigation Window 3D Mode.
